(19) United States
(12) Patent Application Publication
(10) Pub. No.: US 2014/0170405 A1
(43) Pub. Date: Jun. 19, 2014

(54) PROCESSES FOR PREPARING CURED FILMS, THE RESULTING FILMS, AND PLASMA-INITIATED POLYMERIZABLE COMPOSITIONS

(71) Applicant: FUJIFILM Corporation, Tokyo (JP)

(72) Inventors: Masaomi MAKINO, Ashigarakami-gun (JP); Yoshio INAGAKI, Ashigarakami-gun (JP)

(73) Assignee: FUJIFILM Corporation, Tokyo (JP)

(21) Appl. No.: 14/188,884

(22) Filed: Feb. 25, 2014

Related U.S. Application Data
(63) Continuation of application No. PCT/JP2012/069282, filed on Jul. 30, 2012.

(30) Foreign Application Priority Data
Aug. 26, 2011 (JP) 2011-184373
Feb. 8, 2012 (JP) 2012-025062

(51) Int. Cl. C08J 5/18

(52) U.S. Cl. CPC C08J 5/18
USPC 428/220; 427/488; 526/285; 526/261; 526/282

(57) ABSTRACT

Provided are novel plasma-assisted processes for preparing cured films having excellent heat resistance and moisture resistance.

A process for preparing a cured film, comprising at least: applying a composition containing (A) at least one conductive polymer precursor on a substrate to form a coating layer, and irradiating the coating layer with a plasma to polymerize the conductive polymer precursor (A).

The present application is a continuation of PCT/JP2012/069282 filed on Jul. 30, 2012 and claims priority under 35 U.S.C. §119 of Japanese Patent Application No. 184373/2011, filed on Aug. 26, 2011, and Japanese Patent Application No. 025062/2012, filed on Feb. 8, 2012, the content of which are herein incorporated by reference in their entirety.

### TECHNICAL FIELD

The present invention relates to plasma-assisted processes for preparing cured films, the resulting films having a low surface resistance and a high degree of cure, and plasma-initiated polymerizable compositions useful for preparing them.

### RELATED ART

Conventionally, cured organic films have been used for various applications such as optical materials, electric materials and the like. Cured organic films are typically formed by photoirradiating or heating a polymerizable composition containing a polymerizable monomer or a polymer having a crosslinking group and a polymerization initiator so that the monomer is polymerized or the polymer is crosslinked to construct a polymer network structure. However, conventional approaches for forming cured organic films had various disadvantages: i.e., polymerizable monomers are unstable (susceptible to corrosion and promoted polymerization during storage); and starting polymerizable compositions are difficult to handle and cannot be stored in the presence of a polymerization initiator, etc.

On the other hand, plasma-assisted surface modification techniques have been known. However, monomers used in the conventional plasma-assisted surface modification techniques are limited in their molecular weight, molecular structure and the like because the monomers are vaporized. Further, such techniques are not suitable for forming patterned films or forming films within porous bodies, and they are also limited in the range to which surface modification can be applied.

The conventional plasma-assisted techniques were mainly batch processes requiring large-scale equipment and therefore, they were also impractical in terms of productivity because plasma irradiation takes place in vacuum or at high temperatures. They also had the disadvantage that the surfaces of organic materials were inevitably degraded by exposure to high temperatures or electrical discharges. In 1987, researchers succeeded in generating a relatively low temperature plasma at atmospheric pressure by inducing an intermittent discharge in a rare gas (e.g., see non-patent document 1), and disclosed a technique for applying the atmospheric pressure plasma to surface treatment of substrates. Surface treatment techniques using medium to low temperature plasma irradiation are described in patent documents 1 to 3. Patent document 3 describes that a polymerizable monomer is applied as liquid drops by spray coating to form a thin film on the surface of a given base material, but does not describe that a coating solution containing a solvent is applied to form a coating layer. An alternative method has also been proposed, which comprises irradiating an aerosolized film-forming material with a plasma to form a coating layer, and then irradiating the coating layer with UV light to cure it (patent document 4). However, this method requires the film-forming material to be aerosolized so that additional equipments and steps are needed. Another problem is that equipments are contaminated with aerosols or liquid droplets applied by spray coating.

On the other hand, films formed by using alkyne compounds are known to contain carbon-carbon double bonds in their matrices so that they show higher heat resistance and moisture resistance as compared with films containing only carbon-carbon single bonds. Film-forming compositions containing a specific monomeric alkyne compound have also been proposed (e.g., patent document 5). However, alkyne compounds typically begin to polymerize at high temperatures, and when a film is formed from such a compound on a substrate having low heat resistance such as a polymer film, for example, the substrate or other components may be deteriorated by promoted polymerization reaction at high temperatures.

Further, patent document 6 describes that a monomer gas is plasmatized and then vapor-deposited on a substrate whereby it is plasma-polymerized. Such plasma polymerization has the disadvantage that the equipment tends to have a large area because the equipment requires a large area. Finally, patent document 7 describes that an organic metal-containing compound is applied by solvent coating and irradiated with a plasma.

### REFERENCES

### Patent Documents

Patent document 1: JP-A-H6-182195
Patent document 2: JP-A2008-60115
Patent document 3: JP-A2009-25604
Patent document 4: JP-A2010-523814
Patent document 5: JP-A2007-161785
Patent document 6: JP-A2009-516031
Patent document 7: JP-A2006-324105

### Non-Patent Documents

Non-patent document 1: S. Kanazawa, M. Kogoma, T. Moriwaki, S. Okazaki, Proceedings of Japan Symposium on Plasma Chemistry, 3, 1839 (1987).

### SUMMARY OF THE INVENTION

### Problems to be Solved by the Invention

The present invention aims to provide a novel plasma-assisted process for preparing a cured film having excellent heat resistance and moisture resistance.

The present invention also aims to provide a film having excellent heat resistance and moisture resistance, and a plasma-initiated polymerizable composition useful for preparing it.

### Means for Solving the Problems

Means for solving the problems described above are shown below in [1], preferably [2] to [23].

[1] A process for preparing a cured film, comprising at least: applying a composition containing (A) at least one conductive polymer precursor on a substrate to form a coating layer, and then
irradiating the coating layer with a plasma to polymerize the conductive polymer precursor (A).
[2] The process for preparing a cured film according to [1], wherein the conductive polymer precursor (A) contains at least one of aromatic groups, heteroaromatic groups and alkynyl groups.
[3] The process for preparing a cured film according to [1] or [2], wherein the conductive polymer precursor (A) is a precursor of a polymer having any one kind of polythiophene, polyaniline, polypyrrole, and polyacetylene as the main backbone.
[4] The process for preparing a cured film according to any one of [1] to [3], wherein the conductive polymer precursor (A) is a compound having a molecular weight of 230 or more.
[5] The process for preparing a cured film according to any one of [1] to [4], wherein the conductive polymer precursor (A) is a compound having two or more terminal ethynyl groups in one molecule.
[6] The process for preparing a cured film according to any one of [1] to [5], wherein the conductive polymer precursor (A) is a compound having a partial structure represented by formula (1) below:

HC≡C—X— Formula (1)

wherein formula (1), X represents a divalent group consisting of an alkylene group optionally interrupted by one or more carbonyl groups, one or more heteroatoms or a combination thereof, an arylene group optionally interrupted by one or more heteroatoms, a heteroarylene group optionally interrupted by one or more heteroatoms, or a combination thereof, wherein these groups may have one or more substituents.
[7] The process for preparing a cured film according to any one of [1] to [6], wherein the conductive polymer precursor (A) is a compound represented by formula (1a):

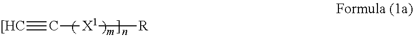

wherein formula (1a), X¹ represents a divalent group consisting of an alkylene group optionally interrupted by one or more carbonyl groups, one or more heteroatoms or a combination thereof, an arylene group optionally interrupted by one or more heteroatoms, a heteroarylene group optionally interrupted by one or more heteroatoms, or a combination thereof, wherein these groups may have one or more substituents; m represents 0 or 1; n represents a number of 1 to 10; R represents a hydrogen atom, a single bond, a n-valent organic group, or a residue of a repeat unit constituting a polymer or an oligomer; and when n is 2 or more, two or more CH≡C—(X¹)ₘ— moieties may be the same or different.
[8] The process for preparing a cured film according to any one of [1] to [7], wherein the conductive polymer precursor (A) is a compound represented by formula (2) below, or a polymer having a repeat unit represented by formula (3) below:

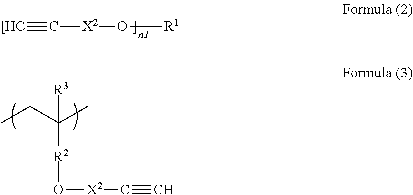

wherein formulae (2) and (3), R¹ represents a parent structure of a polyhydric alcohol or a parent structure of a polyhydric phenol; X² represents a divalent group consisting of an alkylene group optionally interrupted by one or more carbonyl groups, one or more, heteroatoms or a combination thereof, an arylene group optionally interrupted by one or more heteroatoms, a heteroarylene group optionally interrupted by one or more heteroatoms, or a combination thereof, wherein these groups may have one or more substituents; n1 represents an integer of 2 to 6; R² represents a single bond, an alkylene group optionally interrupted by one or more carbonyl groups, one or more heteroatoms or a combination thereof, or an arylene group optionally interrupted by one or more heteroatoms; and R³ represents a hydrogen atom, or an alkyl group.
[9] The process for preparing a cured film according to [8], wherein X² in formulae (2) and (3) represents an alkylene group containing 1 to 5 carbon atoms.
[10] The process for preparing a cured film according to any one of [1] to [9], wherein the composition further contains at least one of (B) a polymerization initiator, (C) a chain transfer agent, (D) a binder, (E) a doping agent, and (F) a solvent.
[11] The process for preparing a cured film according to [10], wherein the polymerization initiator (B) is a peroxide.
[12] The process for preparing a cured film according to [10] or [11], wherein the chain transfer agent (C) is a thiol compound.
[13] The process for preparing a cured film according to any one of [1] to [12], wherein the substrate is a polymer film.
[14] The process for preparing a cured film according to any one of [1] to [13], wherein the cured film has a surface resistivity of 10¹²Ω/□ or less.
[15] The process for preparing a cured film according to any one of [1] to [14], comprising applying a composition containing (A) at least one conductive polymer precursor on a substrate to form a coating layer and then partially irradiating the coating layer with a plasma to partially polymerize the conductive polymer precursor (A), thereby forming a surface having different surface resistivities.
[16] The process for preparing a cured film according to any one of [1] to [15], wherein the plasma is a low temperature atmospheric pressure plasma.
[17] The process for preparing a cured film according to any one of [1] to [16], wherein the plasma is formed from anyone or more of nitrogen, oxygen, hydrogen, argon, helium, ammonia and carbon dioxide gases.
[18] A cured film prepared by polymerizing the conductive polymer precursor (A) by the process according to any one of [1] to [17].
[19] A cured film obtained by curing a composition containing at least one member selected from a compound represented by formula (2) below or a polymer and oligomer having a repeat unit represented by formula (3) below:

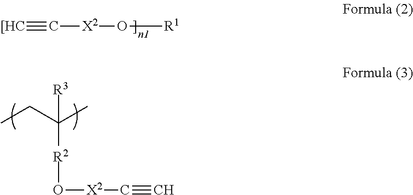

wherein formulae (2) and (3), R¹ represents the parent structure of a polyhydric alcohol or the parent structure of a polyhydric phenol; X² represents a divalent group consisting of an alkylene group optionally interrupted by one or more carbonyl groups, one or more heteroatoms or a combination thereof, an arylene group optionally interrupted by one or more heteroatoms, a heteroarylene group optionally interrupted by one or more heteroatoms, or a combination thereof, wherein these groups may have one or more substituents; n1 represents an integer of 2 to 6; R² represents a single bond, an alkylene group optionally interrupted by one or more carbonyl groups, one or more heteroatoms or a combination thereof, or an arylene group optionally interrupted by one or more heteroatoms; and R³ represents a hydrogen atom, or an alkyl group.
[20] The cured film according to [18] or [19], which has a thickness of 1 to 500 nm.
[21] A cured film having a surface resistivity of less than 10¹²Ω/□ prepared by the process according to any one of [1] to [17].
[22] A patterned organic conductive film prepared by the process according to [15], which comprises a discrete region having a surface resistivity of 10²Ω/□ or more in the same surface.
[23] A plasma-initiated polymerizable composition containing at least one member selected from a compound represented by formula (2) below, and a polymer or oligomer having a repeat unit represented by formula (3) below:

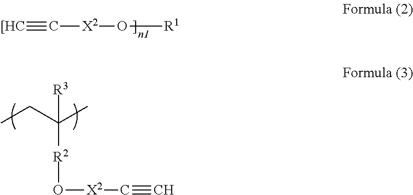

wherein formulae (2) and (3), R¹ represents the parent structure of a polyhydric alcohol or the parent structure of a polyhydric phenol; X² represents a divalent group consisting of an alkylene group optionally interrupted by one or more carbonyl groups, one or more heteroatoms or a combination thereof, an arylene group optionally interrupted by one or more heteroatoms, a heteroarylene group optionally interrupted by one or more heteroatoms, or a combination thereof, wherein these groups may have one or more substituents; n1 represents an integer of 2 to 6; R² represents a single bond, an alkylene group optionally interrupted by one or more carbonyl groups, one or more heteroatoms or a combination thereof, or an arylene group optionally interrupted by one or more heteroatoms; and R³ represents a hydrogen atom, or an alkyl group.

### Advantages of the Invention

According to the present invention, novel plasma-assisted processes for preparing cured films having excellent heat resistance and moisture resistance can be provided.

Also according to the present invention, films having excellent heat resistance and moisture resistance can be provided as well as plasma-initiated polymerizable compositions useful for preparing them.

### BRIEF EXPLANATION OF THE DRAWINGS

FIG. 1 is a graph showing the results of evaluation of the degree of cure in Example 3.

### THE BEST EMBODIMENTS OF THE INVENTION

The present invention will be explained in detail below. As used herein, the numerical ranges expressed with “to” are used to mean the ranges including the values indicated before and after “to” as lower and upper limits.

Also as used herein, the terms “cured film” and “film” mean to include all of self-supporting films, and layers and films formed on substrates.
Also as used herein, the term “plasma-initiated polymerizable” refers to the property of inducing polymerization by exited species formed by plasma irradiation whereby polymerization starts/proceeds, but has no relation to the polymerizability in conventional photopolymerization and thermal polymerization or the plasma polymerizability meaning the property of inducing polymerization via bond cleavage or bond recombination or bond formation in a plasmatized organic gas.
Also as used herein, the term “a plasma-initiated polymerizable composition containing (A) at least one conductive polymer precursor” means to include a composition solely composed of at least one conductive polymer precursor as well as a composition containing one or more additives such as polymerization initiator, chain transfer agent and the like in addition to at least one conductive polymer precursor.

1. Processes for Preparing Cured Films

The present invention relates to processes for preparing a cured film, comprising at least:

applying (preferably by coating) a composition containing (A) at least one conductive polymer precursor on a substrate to form a coating layer, and then
irradiating the coating layer with a plasma to polymerize the conductive polymer precursor (A), thereby curing it. Plasma irradiation allows the conductive polymer precursor to rapidly polymerize even at low temperatures. The resulting cured film also contains carbon-carbon double bonds in its matrix so that it shows high crosslink density, and therefore high heat resistance and moisture resistance. Further, the conductive polymer precursor is easy to store/handle because it does not show the conventional photopolymerizability and thermal polymerizability at low temperatures such as room temperature. According to the processes of the present invention, problems associated with the presence of the decomposition product of a polymerization initiator can also be reduced because polymerization can be initiated in the absence of the polymerization initiator. Thus, incorporation of impurities can be avoided and a high purity film can be formed. Further, the processes of the present invention allow a coating layer to be formed by applying a composition containing a solvent and then the coating layer to be cured by plasma irradiation, whereby the equipment and the like are not contaminated with aerosols of monomers or liquid droplets of monomers. Further, the processes of the present invention provide a cured film having low surface resistance. The surface resistivity of the cured film formed by the processes of the present invention can be 10¹²Ω/□ (ohm/sq) or less, or even 10³ to 10⁸Ω/□ in contrast to typical polymer films having a surface resistivity on the order of 10¹⁵Ω/□.

(1) Plasma-Initiated Polymerizable Composition

The processes of the present invention employ a plasma-initiated polymerizable composition having the property of beginning to polymerize upon plasma irradiation, containing (A) at least one conductive polymer precursor at the minimum.

(A) Conductive Polymer Precursors

The conductive polymer shown in the conductive polymer precursor used in the present invention means to include π-conjugated conductive polymers. They are not specifically limited to any structure, and examples that can be used include chain-like conductive polymers such as polythiophenes (including polythiophene per se; the same applies hereinafter), polypyrroles, polyindoles, polycarbazoles, polyanilines, polyacetylenes, polyfurans, poly(p-phenylene vinylenes), polyazulenes, poly(p-phenylenes), poly(p-phenylene sulfides), polyisothianaphthenes, and polythiazyls. Among others, polythiophenes, polyanilines and polyacetylenes are preferred because of conductivity, transparency, stability and the like. Most preferred are polyacetylenes. Preferably, the conductive polymer precursor used in the present invention is substantially free from metal. The expression “substantially free from” means that the content is, for example, 2% by mass or less based on the mass of the conductive polymer precursor.

The precursor used for forming the conductive polymer contains a π-conjugated system or an acetylene bond in its molecule so that a π-conjugated system is also formed in the main chain of the resulting polymer after oxidative polymerization or reductive polymerization has proceeded under the action of a plasma. For example, it is preferably a compound containing at least one of aromatic groups, heterocyclic aromatic groups and alkynyl groups, more preferably a precursor of a polymer having any one of kind of polythiophene, polyaniline, polypyrrole, and polyacetylene skeletons as the main backbone. Such compounds include thiophenes and derivatives thereof, anilines and derivatives thereof, pyrroles and derivatives thereof, and acetylenes and derivatives thereof.

Specific examples of conductive polymer precursors preferably include at least one member selected from the group consisting of thiophene, pyrrole, aniline, acetylene and derivatives thereof. Examples of conductive polymer precursors include, for example, thiophene derivatives such as alkylthiophenes (e.g., 3-methylthiophene, 3,4-dimethylthiophene, 3-hexylthiophene, 3-stearylthiophene, 3-benzylthiophene, 3-methoxydiethoxymethylthiophene), halogenated thiophenes (e.g., 3-chlorothiophene, 3-bromothiophene), arylthiophenes (3-phenylthiophene, 3,4-diphenylthiophene, 3-methyl-4-phenylthiophene), alkoxythiophenes (e.g., 3,4-dimethoxythiophene, 3,4-ethylenedioxythiophene) and the like; pyrrole derivatives such as N-alkylpyrroles (e.g., N-methylpyrrole, N-ethylpyrrole, methyl-3-methylpyrrole, N-methyl-3-ethylpyrrole), N-arylpyrroles (e.g., N-phenylpyrrole, N-naphthylpyrrole, N-phenyl-3-methylpyrrole, N-phenyl-3-ethylpyrrole), 3-alkylpyrroles (e.g., 3-methylpyrrole, 3-ethylpyrrole, 3-n-butylpyrrole), 3-arylpyrroles (e.g., 3-phenylpyrrole, 3-toluylpyrrole, 3-naphthylpyrrole), 3-alkoxypyrroles (e.g., 3-methoxypyrrole, 3-ethoxypyrrole, 3-n-propoxypyrrole, 3-n-butoxypyrrole), 3-aryloxypyrroles (e.g., 3-phenoxypyrrole, 3-methylphenoxypyrrole), 3-aminopyrroles (e.g., 3-dimethylaminopyrrole, 3-diethylaminopyrrole, 3-diphenylaminopyrrole, 3-methylphenylaminopyrrole, 3-phenylnaphthylaminopyrrole) and the like; aniline derivatives such as alkylanilines (e.g., o-methylaniline, m-methylaniline, o-ethylaniline, m-ethylaniline, o-ethoxyaniline, m-butylaniline, m-hexylaniline, m-octylaniline, 2,3-dimethylaniline, 2,5-dimethylaniline), alkoxyanilines (e.g., m-methoxyaniline, 2,5-dimethoxyaniline), aryloxyanilines (e.g., 3-phenoxyaniline), cyanoanilines (e.g., o-cyanoaniline, m-cyanoaniline), halogenated anilines (e.g., m-chloroaniline, 2,5-dichloroaniline, 2-bromoaniline, 5-chloro-2-methoxyaniline) and the like; acetylene derivatives such as phenylacetylene, 1,4-diethynylbenzene, 1,3-diethynylbenzene, 1,2-diethynylbenzene, 1,3,5-triethynylbenzene and the like. Preferred conductive polymer precursors are thiophene derivatives and acetylene derivatives.

The conductive polymer precursor may be a multimer (polymer).

More preferably, the conductive polymer precursor has a molecular weight of 230 or more to improve handling properties or to reduce surface resistance. More preferably, the conductive polymer precursor has a molecular weight of 240 or more, even more preferably 230 to 1,000,000, still more preferably 240 to 100,000.

More preferably, the conductive polymer precursor is an alkyne compound, most preferably an alkyne compound represented by one of the structures shown below. Upon plasma irradiation, the conductive polymer precursor polymerizes and becomes conductive, whereby surface resistance decreases. Especially, crosslinked polyacetylene films formed by plasma-assisted polymerization of alkyne compounds are characterized in that they are not only conductive and show low surface resistance but also they are excellent in maximum allowable heatproof temperature and moisture resistance because they are firmly crosslinked via vinyl groups.

(A) Alkyne Compounds:

The alkyne compound (A) used in the present invention can be any alkyne compound so far as it can begin to polymerize. To improve film-forming properties, preferred are alkyne compounds having two or more ethynyl groups in one molecule, especially alkyne compounds having two or more terminal ethynyl (CH≡C—) groups (preferably about 2 to 10, more preferably 2 to 8, even more preferably 2 to 6 in low molecular weight compounds or 7 to 10,000, more preferably 7 to 1,000 in high molecular weight compounds) in one molecule. These compounds are preferred because they can form a film having a higher degree of cure, therefore higher heat resistance and moisture resistance as compared with alkyne compounds having one ethynyl group in one molecule.

To improve film-forming properties, the alkyne compound more preferably has a higher molecular weight, and the alkyne compound may be a polymer having an ethynyl group in a side chain. However, compounds having an excessively high molecular weight may not dissolve during preparation of a coating solution or may be poor in other handling properties. For these reasons, the alkyne compound preferably has a molecular weight of 230 or more, more preferably 240 or more, even more preferably 230 to 1,000,000, still more preferably 240 to 100,000. However, the molecular weight of the alkyne compound is not limited to these ranges because film-forming properties can also be improved by incorporating a binder or the like into the composition.

To improve film-forming properties, more preferred are compounds having two or more terminal ethynyl (CH≡C—) groups (preferably about 2 to 10, more preferably 2 to 6 in low molecular weight compounds or 7 to 10,000 or less, more preferably 7 to 1,000 in high molecular weight compounds) in one molecule and having a molecular weight of 240 or more (more preferably 240 to 10,000).

One example is an alkyne compound having a partial structure represented by formula (1) below:

HC≡C—X— Formula (1)

In formula (1), X represents a divalent group consisting of an alkylene group optionally interrupted by one or more carbonyl groups, one or more heteroatoms or a combination thereof, an arylene group optionally interrupted by one or more heteroatoms, a heteroarylene group optionally interrupted by one or more heteroatoms, or a combination thereof, wherein these groups may have one or more substituents.

The alkylene group represented by X may be any of straight-chain, branched-chain, and cyclic groups. It may also be a combination thereof (e.g.; a combination of a straight-chain alkylene group and a branched-chain or cyclic alkylene group). Preferably, it contains 1 to 20, more preferably 1 to 10, even more preferably 1 to 5 carbon atoms.

The alkylene group represented by X may be interrupted by one or more carbonyl groups, one or more heteroatoms, or a combination thereof. Examples of the heteroatoms include —O—, —NH—, —NR— (wherein R represents a substituent such as an alkyl group containing about 1 to 5 carbon atoms), and —S—. Further, examples of combinations of one or more carbonyl groups and one or more heteroatoms include —C(═O)O—, —OC(═O)—, —C(═O)NH—, —NH—C(═O)—, —C(═O)NR—, —NR—C(═O)—, —O—C(═O)—NH—, —NH—C(═O)—O—, —O—C(═O)—NR—, —NR—C(═O)—O—, and —O—C(═O)—O—.

Examples of alkylene groups interrupted by heteroatoms include polyethyleneoxy groups (e.g., polyethyleneoxy groups consisting of 1 to 30 repeat units), straight-chain or branched-chain polypropyleneoxy groups (e.g., polypropyleneoxy groups consisting of 1 to 30 repeat units) and the like.

Further, the alkylene groups interrupted by heteroatoms or the like may be identical to or different from each other. Specifically, one alkylene group and the other alkylene group interrupted by heteroatoms or the like may contain different numbers of carbon atoms, or one may be a straight-chain alkylene group and the other may be a branched-chain or cyclic alkylene group. When the alkylene groups include a cyclic alkylene group, the ring carbon atoms forming the cyclic alkylene may be substituted by one or more carbonyl groups, one or more heteroatoms, or a combination thereof.

Examples of alkylene groups interrupted by heteroatoms include polyethyleneoxy groups (e.g., polyethyleneoxy groups consisting of 1 to 30 repeat units), straight-chain or branched-chain polypropyleneoxy groups (e.g., polypropyleneoxy groups consisting of 1 to 30 repeat units) and the like.

The arylene group represented by X may be a monocycle or a fused ring system. Examples of arylene groups also include monocyclic or fused ring arylene groups linked via a single bond, wherein two or more arylene groups linked together may be identical to or different from each other. The heteroarylene group (divalent heteroaromatic ring) represented by X may also be a monocycle or a fused ring system. Examples of fused ring systems include all of fused ring systems composed of two or more identical heteroaromatic rings fused together, fused ring systems composed of two or more different heteroaromatic rings fused together, and fused ring systems composed of one or more heteroaromatic rings and one or more aromatic hydrocarbon rings and/or one or more aliphatic hydrocarbon rings fused together. Examples of heteroarylene groups also include monocyclic or fused heteroarylene groups linked via a single bond, wherein two or more heteroarylene groups linked together may be identical to or different from each other.

The arylene groups and heteroarylene groups may be interrupted by one or more heteroatoms, i.e., two or more arylene groups or heteroarylene groups may be linked via heteroatoms. Examples of heteroatoms are the same as the examples of heteroatoms capable of interrupting alkylene groups represented by X.

Preferably, the arylene group is a phenylene group, or a combination of two or more (preferably 2 to 6) phenylene groups linked together via a single bond or a heteroatom. Examples of heteroarylene groups include pyridyl, quinolyl, thiazolyl, benzothiazolyl, thiadiazolyl, and thienothiazolyl.

Alternatively, X represents a divalent group consisting of a combination of the specific alkylene groups, specific arylene groups, and specific heteroarylene groups described above. Examples include two or more arylene groups or heteroarylene groups linked via a straight-chain, branched-chain or cyclic alkylene group, and one arylene group or heteroarylene group substituted by one or more straight-chain, branched-chain or cyclic alkylene groups, and the like. It should be understood that these alkylene groups and the like may also be interrupted by heteroatoms and the like as described above.

These groups consisting of an alkylene group, an arylene group, a heteroarylene group, and a combination thereof may have one or more substituents, if possible. Examples of substituents on alkylene groups include aryl, hydroxyl, heteroaryl, carboxyl, thiol, sulfonyl and the like; examples of substituents on arylene groups include alkyl, hydroxyl, heteroaryl, carboxyl, thiol, sulfonyl, halogen atoms and the like; and examples of substituents on heteroarylene groups include alkyl, hydroxyl, aryl, carboxyl, thiol, sulfonyl, halogen atoms and the like. However, the present invention is not limited to these examples. Further, the group consisting of an alkylene group, an arylene group, a heteroarylene group, and a combination thereof may be substituted by one or more substituents having a terminal ethynyl group.

Examples of alkyne compounds of the present invention include compounds represented by formula (1a) below:

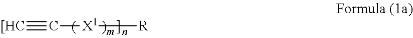

In formula (1a), X¹ represents a divalent group consisting of an alkylene group optionally interrupted by one or more carbonyl groups, one or more heteroatoms or a combination thereof, an arylene group optionally interrupted by one or more heteroatoms, a heteroarylene group optionally interrupted by one or more heteroatoms, or a combination thereof, wherein these groups may have one or more substituents; m represents 0 or 1; n represents a number of 1 to 10; R represents a hydrogen atom, a single bond, a n-valent organic group, or a residue of a repeat unit constituting a polymer or an oligomer; and when n is 2 or more, two or more CH≡C—(X¹)ₘ— moieties may be identical to or different from each other.

In formula (1a), the divalent group consisting of an alkylene group optionally interrupted by one or more carbonyl groups, one or more heteroatoms or a combination thereof, an arylene group optionally interrupted by one or more heteroatoms, or a combination thereof represented by X¹ has the same meaning as defined for the group represented by X in formula (1) above, and also covers similar preferred ranges.

In formula (1a), n represents 1 to 10, preferably 2 to 8, more preferably 2 to 6.

Preferably, R represents a hydrogen atom or a residue of a repeat unit constituting a polymer when n is 1, or R represents a single bond or a divalent organic group when n is 2, or R represents a trivalent or higher valent organic group when n is 3 or more. When R represents a hydrogen atom or a single bond, m is preferably 1. Examples of repeat units represented by R include repeat units derived by radical polymerization from monomers having an ethylenically unsaturated group; repeat units of polyesters derived by condensation polymerization from a carboxylic acid or a derivative thereof and an alcohol; repeat units of polyesters derived by ring-opening polymerization of a lactone; repeat units of polyamides derived by condensation polymerization from a carboxylic acid or a derivative thereof and an amine; repeat units of polyimides derived by further dehydrating the polyamides; repeat units of polyurethanes derived by condensation polymerization from an isocyanate and an alcohol; and the like.

Examples of divalent organic groups represented by R include all of aliphatic organic groups, aromatic organic groups and combinations thereof. Preferably, the divalent organic group represented by R is a divalent group consisting of an alkylene group optionally interrupted by one or more carbonyl groups, one or more heteroatoms or a combination thereof, an arylene group optionally interrupted by one or more heteroatoms, a heteroarylene group optionally interrupted by one or more heteroatoms, or a combination thereof, wherein these groups have the same meanings as defined for the groups represented by X in formula (1) above, and also cover similar preferred ranges. Examples of divalent aliphatic organic groups include alkylene groups and polyalkylene (e.g., ethylene or propylene) oxy groups. Examples of divalent organic groups include aryl groups (e.g., phenyl) or heteroaryl groups substituted by two CH≡C—(X¹)ₘ— moieties.

Examples of trivalent or higher valent organic groups represented by R include all of aliphatic organic groups, aromatic organic groups and combinations thereof. Examples of trivalent or higher valent aliphatic organic groups include aliphatic hydrocarbon groups having a branched structure containing one or more tertiary or quaternary carbon atoms. One carbon atom or two or more non-adjacent carbon atoms contained in the aliphatic hydrocarbon groups may be substituted by a heteroatom such as an oxygen atom. Further, examples of trivalent or higher valent aromatic organic groups include aryl groups (e.g., phenyl) and heteroaryl groups substituted by three or more CH≡C—(X¹)ₘ— moieties. Further, examples of trivalent or higher valent organic groups consisting of a combination thereof include organic groups consisting of an aliphatic hydrocarbon group having a branched structure containing one or more tertiary or quaternary carbon atoms and an aryl group (e.g., phenyl) and a heteroaryl group substituted by one or more CH≡C—(X¹)ₘ— moieties linked via the aliphatic hydrocarbon group; and an aryl group (e.g., phenyl) and a heteroaryl group substituted by three or more aliphatic groups terminated by CH≡C—(X¹)ₘ—, and the like.

Further, examples of the alkyne compound include compounds represented by formula (2) below, or polymers or oligomers having a repeat unit represented by formula (3) below. The compounds represented by formula (2) below, or the polymers or oligomers having a repeat unit represented by formula (3) below are especially excellent in handling properties because they are not polymerized by conventional thermal polymerization and photopolymerization methods even in the presence of a polymerization initiator.

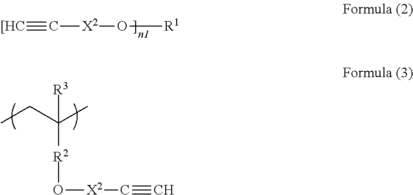

In formulae (2) and (3), R¹ represents a parent structure of a polyhydric alcohol or a parent structure of a polyhydric phenol, X² represents a divalent group consisting of an alkylene group optionally interrupted by one or more carbonyl groups, one or more heteroatoms or a combination thereof, an arylene group optionally interrupted by one or more heteroatoms, a heteroarylene group optionally interrupted by one or more heteroatoms, or a combination thereof, wherein these groups may have one or more substituents; n1 represents an integer of 2 to 6; R² represents a single bond, an alkylene group optionally interrupted by one or more carbonyl groups, one or more heteroatoms or a combination thereof, or an arylene group optionally interrupted by one or more heteroatoms; and R³ represents a hydrogen atom, or an alkyl group.

The parent structure of a polyhydric alcohol represented by R¹ is a n1-valent residue formed by removing n1 hydroxyl groups from a n1-valent polyhydric alcohol. Examples of n1-valent polyhydric alcohols include ethylene glycol, triethylene glycol, 1,3-butanediol, tetramethylene glycol, propylene glycol, neopentyl glycol, trimethylolpropane, trimethylolpropanetri(hydroxypropyl)ether, trimethylolethane, hexanediol, 1,4-cyclohexanediol, tetraethylene glycol, pentaerythritol, dipentaerythritol, sorbitol, tri(hydroxyethyl)isocyanurate, hydroxyl-terminated polyester oligomers, isocyanurate EO-modified alcohols, bis[p-(2,3-dihydroxypropoxy)phenyl]dimethylmethane, bis[p-(hydroxyethoxy)phenyl]dimethylmethane and the like.

The parent structure of a polyhydric phenol represented by R¹ is a n1-valent residue formed by removing n1 hydroxyl groups from a n1-valent polyhydric phenol. Examples of n1-valent polyhydric phenols include formulae P-1 to P-16 below. However, the present invention is not limited to these examples.

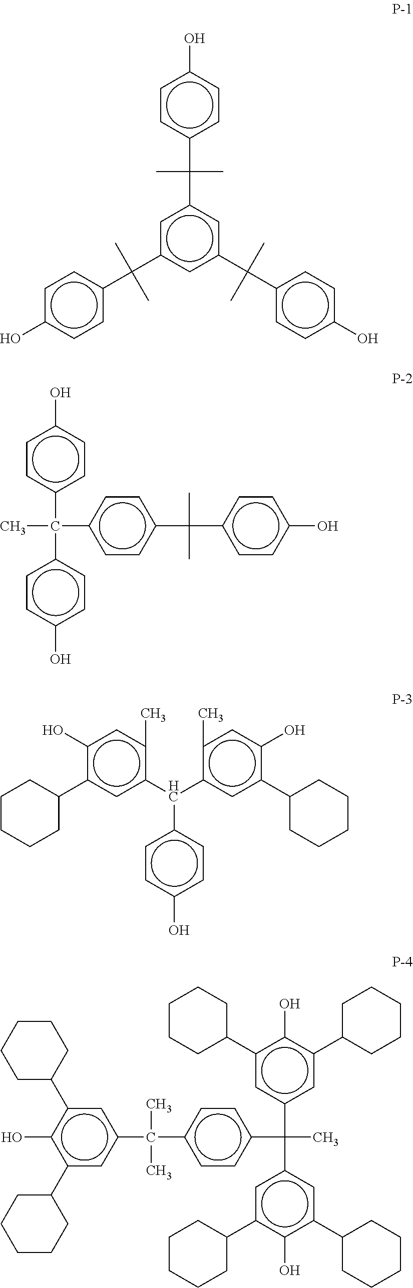

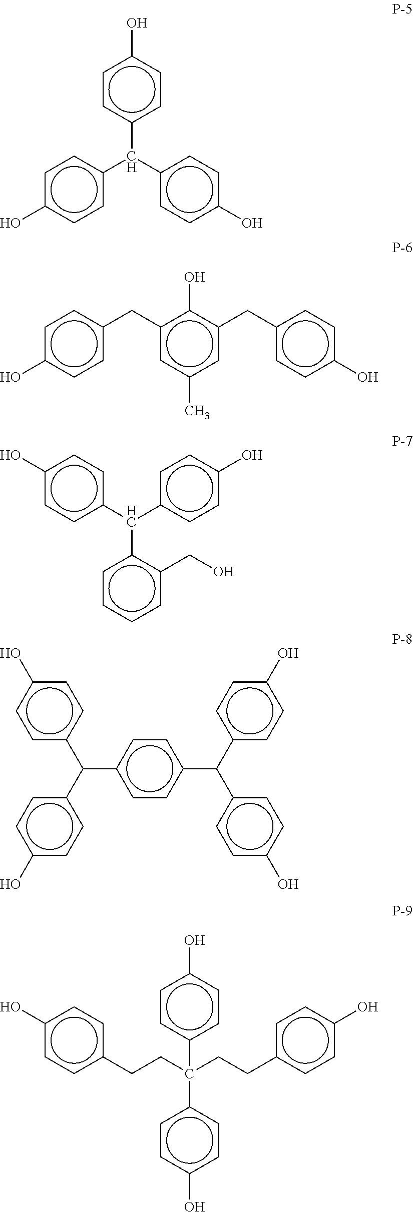

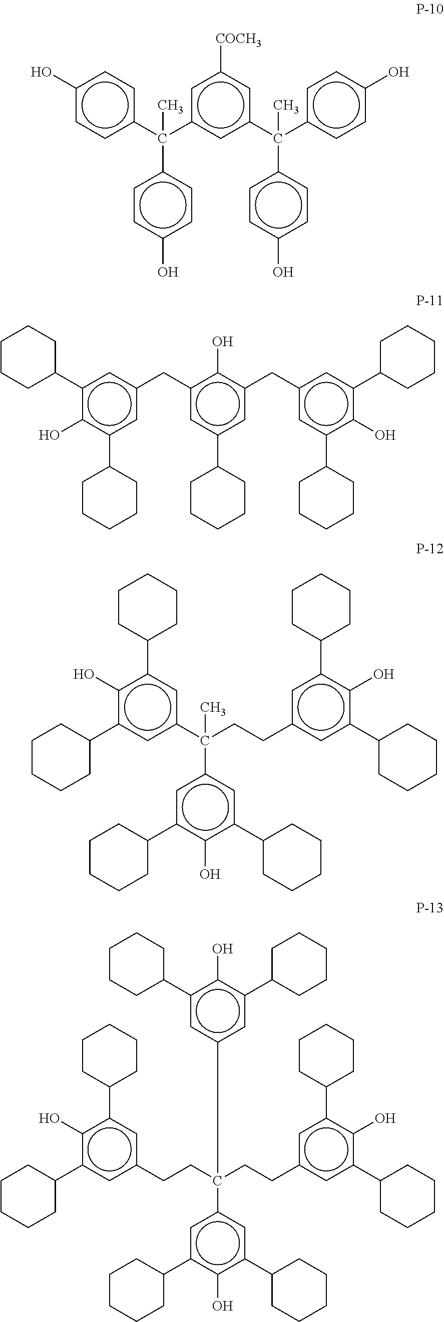

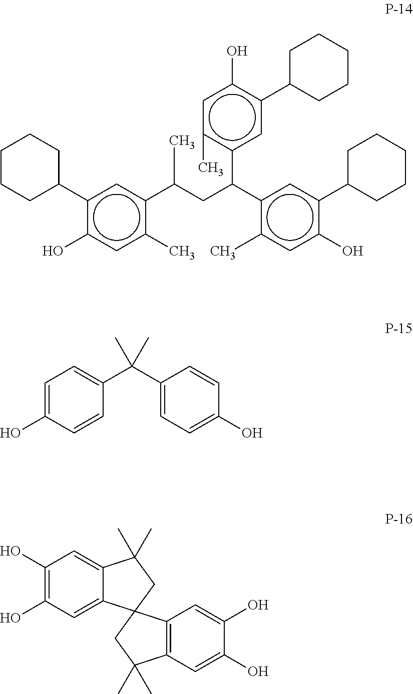

The divalent group consisting of an alkylene group optionally interrupted by one or more carbonyl groups, one or more heteroatoms or a combination thereof, an arylene group optionally interrupted by one or more heteroatoms, or a combination thereof represented by X² and R² has the same meaning as defined for the group represented by X in formula (1) above, and also covers similar preferred ranges. Preferred examples of X² include alkylene groups containing 1 to 5 carbon atoms. Especially preferred are methylene (—CH₂—) and ethylene (—CH₂CH₂—). Preferred examples of R² include phenylene, *—C(═O)O-AL- (wherein the asterisk (*) indicates the point of attachment to the main chain of the polymer, and AL represents an alkylene group containing 1 to 10 carbon atoms optionally interrupted by a heteroatom (e.g., oxygen atom)).

The alkyl group represented by R³ is preferably a lower alkyl group containing 1 to 5 carbon atoms, especially preferably methyl. Preferably, R³ represents a hydrogen atom or methyl. The alkyl group may have a substituent, examples of which include halogen atoms (fluorine atom, chlorine atom, bromine atom, and iodine atom), hydroxyl, carboxyl, —C(O)O—, —OC(O)— and the like.

The polymer or oligomer having a repeat unit represented by formula (3) above may be a homopolymer or the like consisting of only one type of the repeat unit, or a copolymer or the like containing two or more types of repeat units represented by formula (3), or a copolymer or the like containing a repeat unit represented by formula (3) and one or more other repeat units. Examples of other repeat units include repeat units derived from styrenic monomers, acrylic acid or monomeric derivatives thereof (e.g., acrylic acid esters), methacrylic acid or monomeric derivatives thereof (e.g., methacrylic acid esters), cinnamic acid or derivatives thereof, maleic anhydride, maleimide or derivatives thereof and the like.

The average molecular weight of the polymer having a repeat unit represented by formula (3) above is not specifically limited, but preferably 1,000 to 500,000, more preferably 3,000 to 300,000, even more preferably 5,000 to 100,000 to improve both film-forming properties and solubility in solvents.

Specific examples of conductive polymer precursors that can be used in the present invention are shown below, but the present invention is not limited to the specific examples shown below.

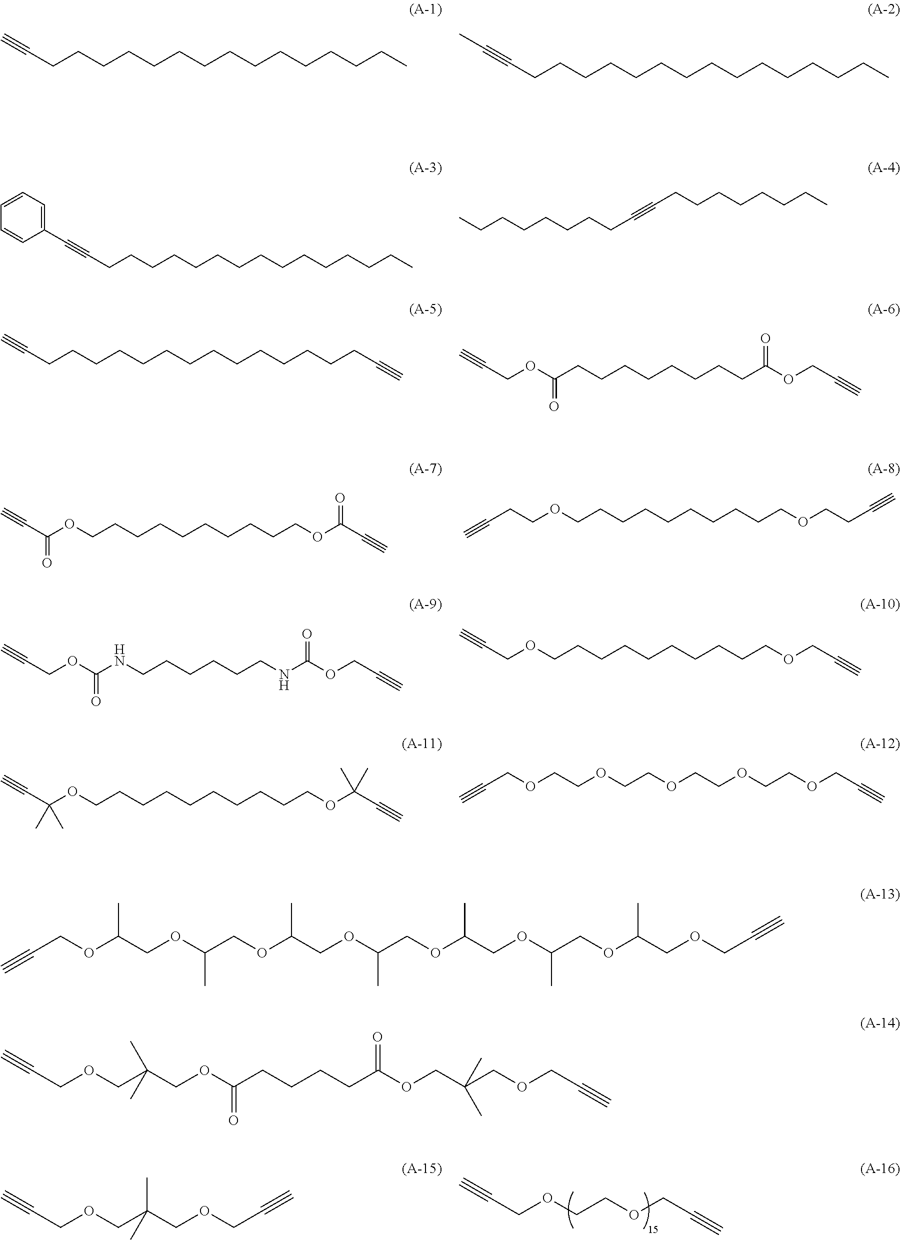

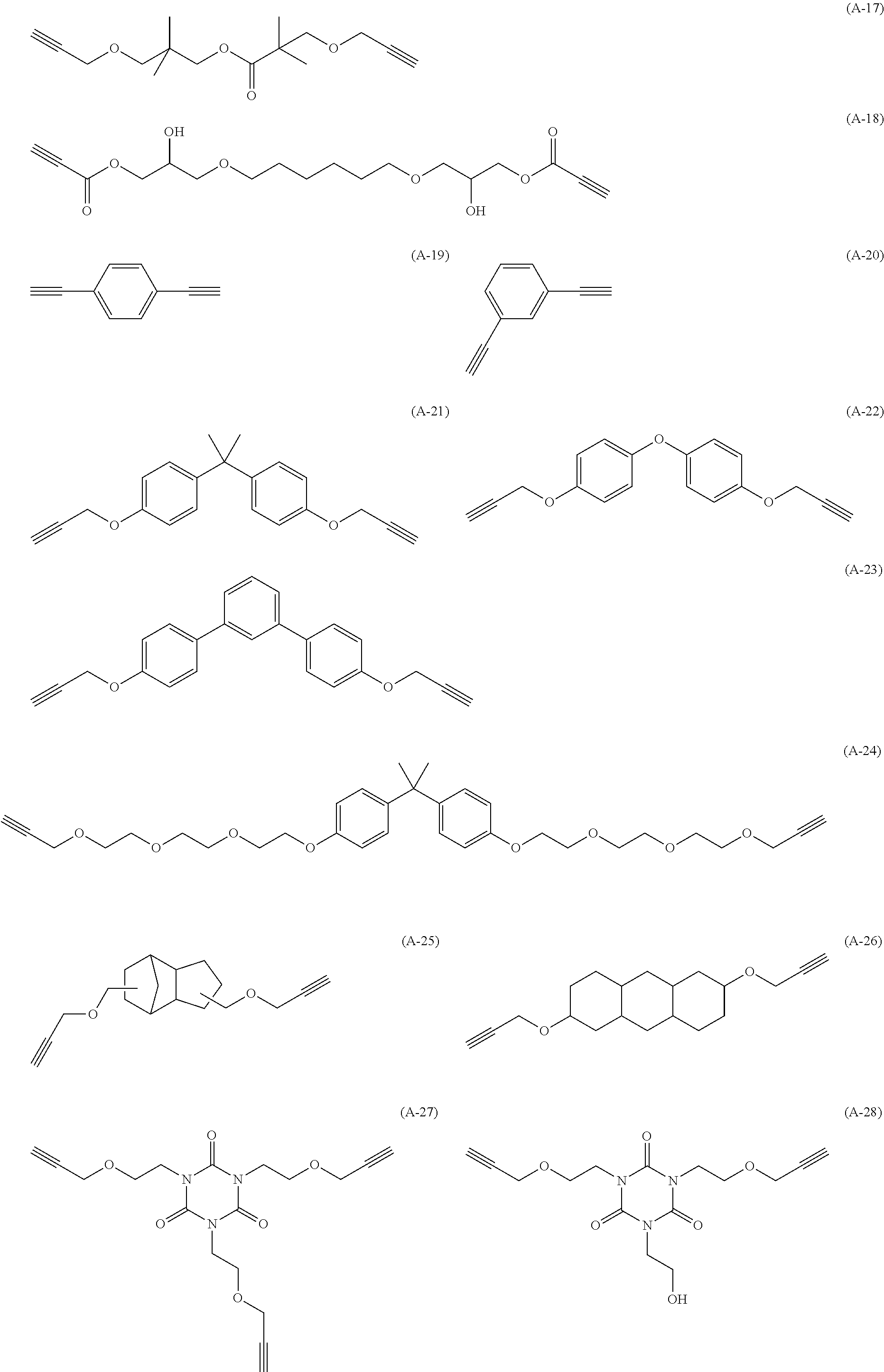

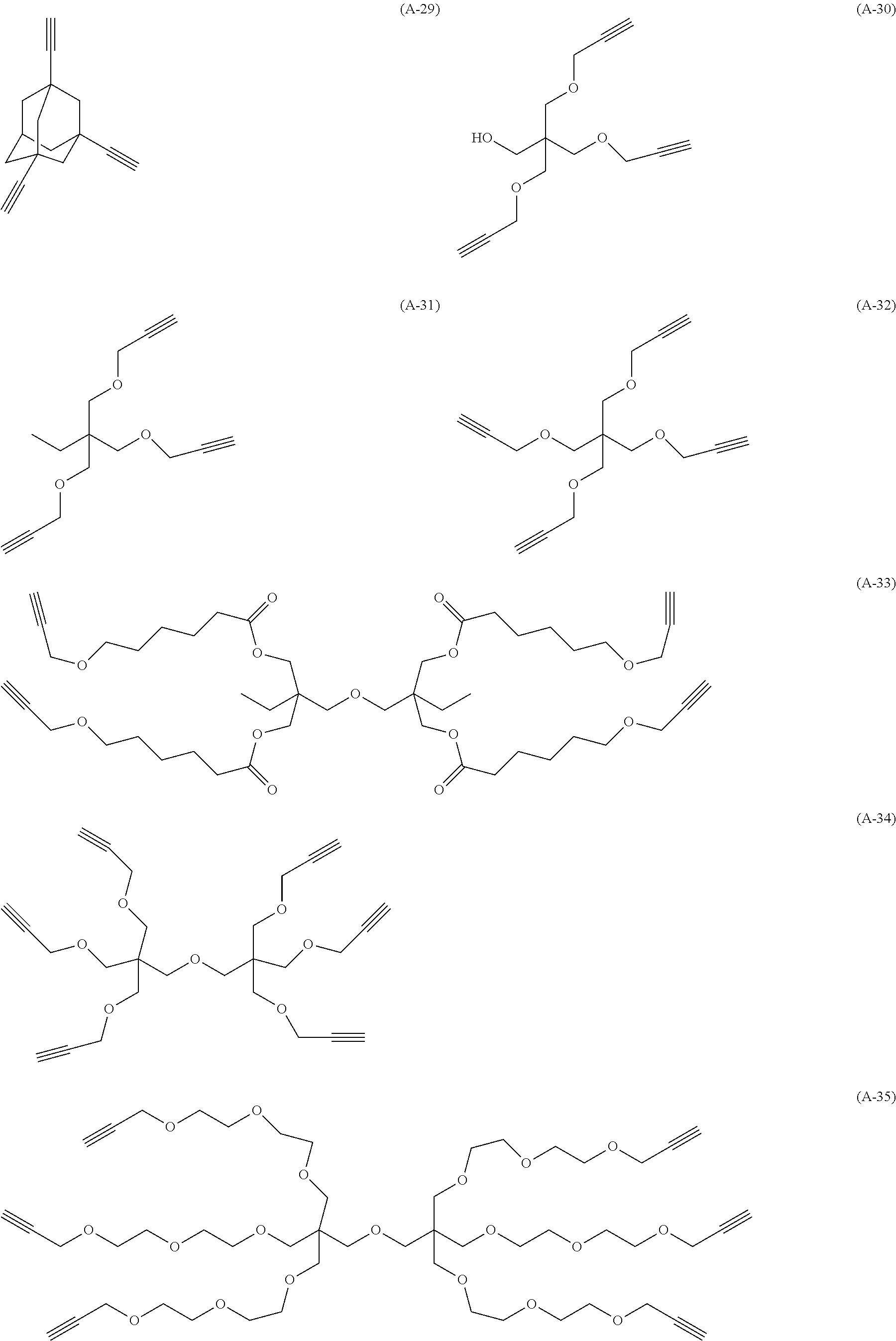

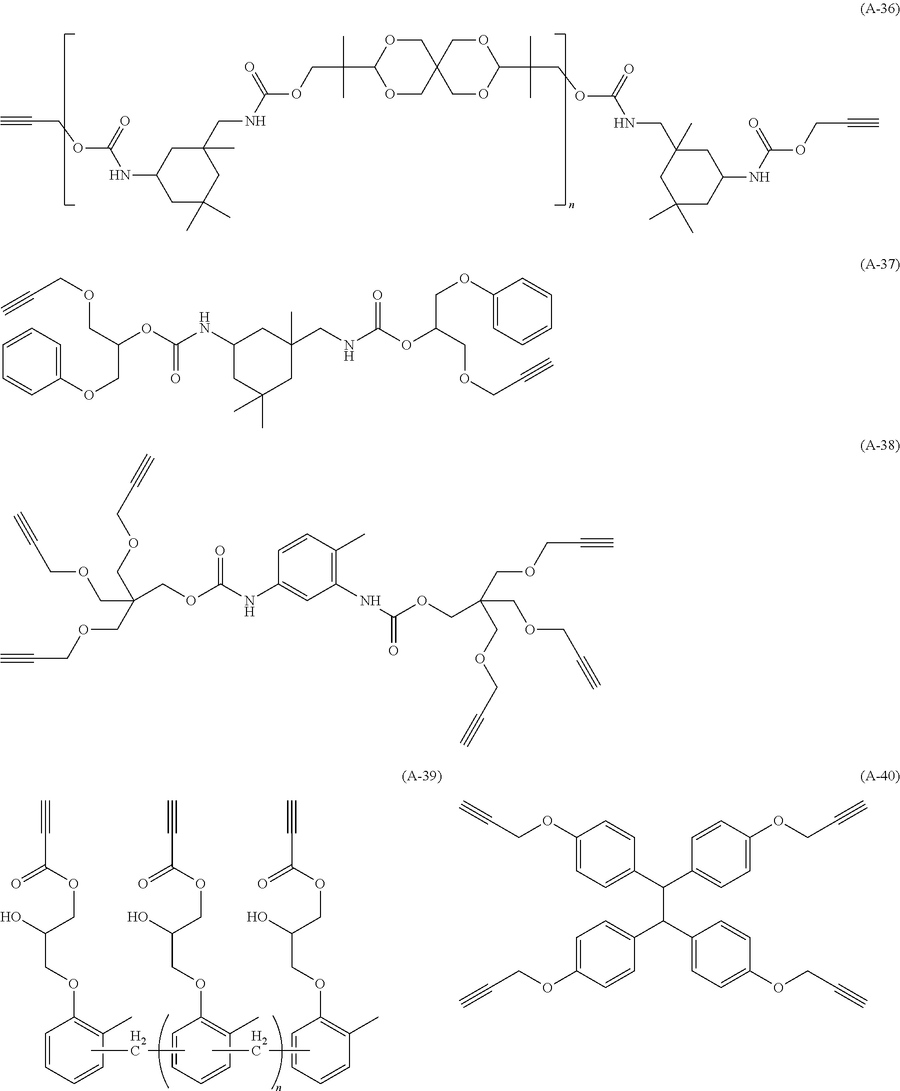

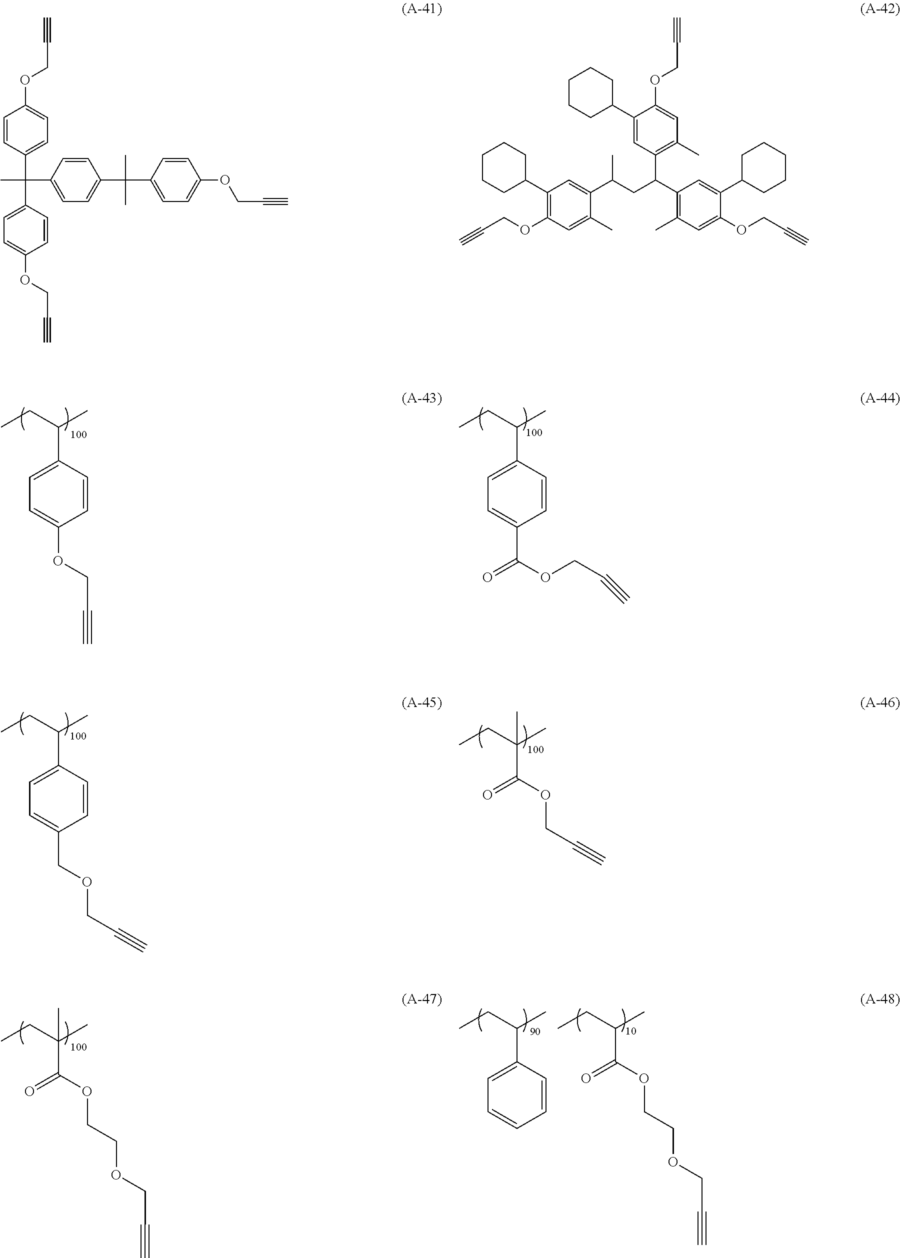

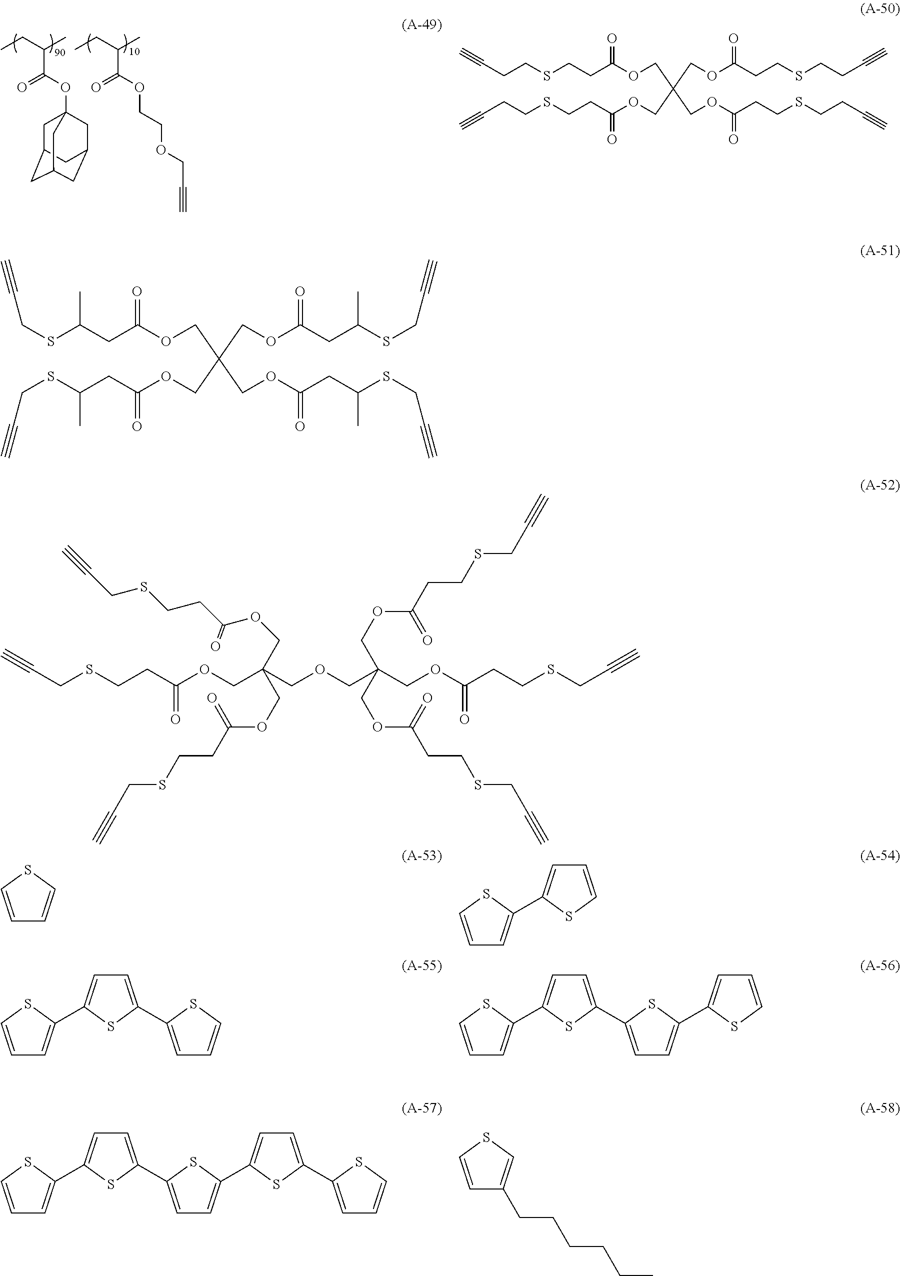

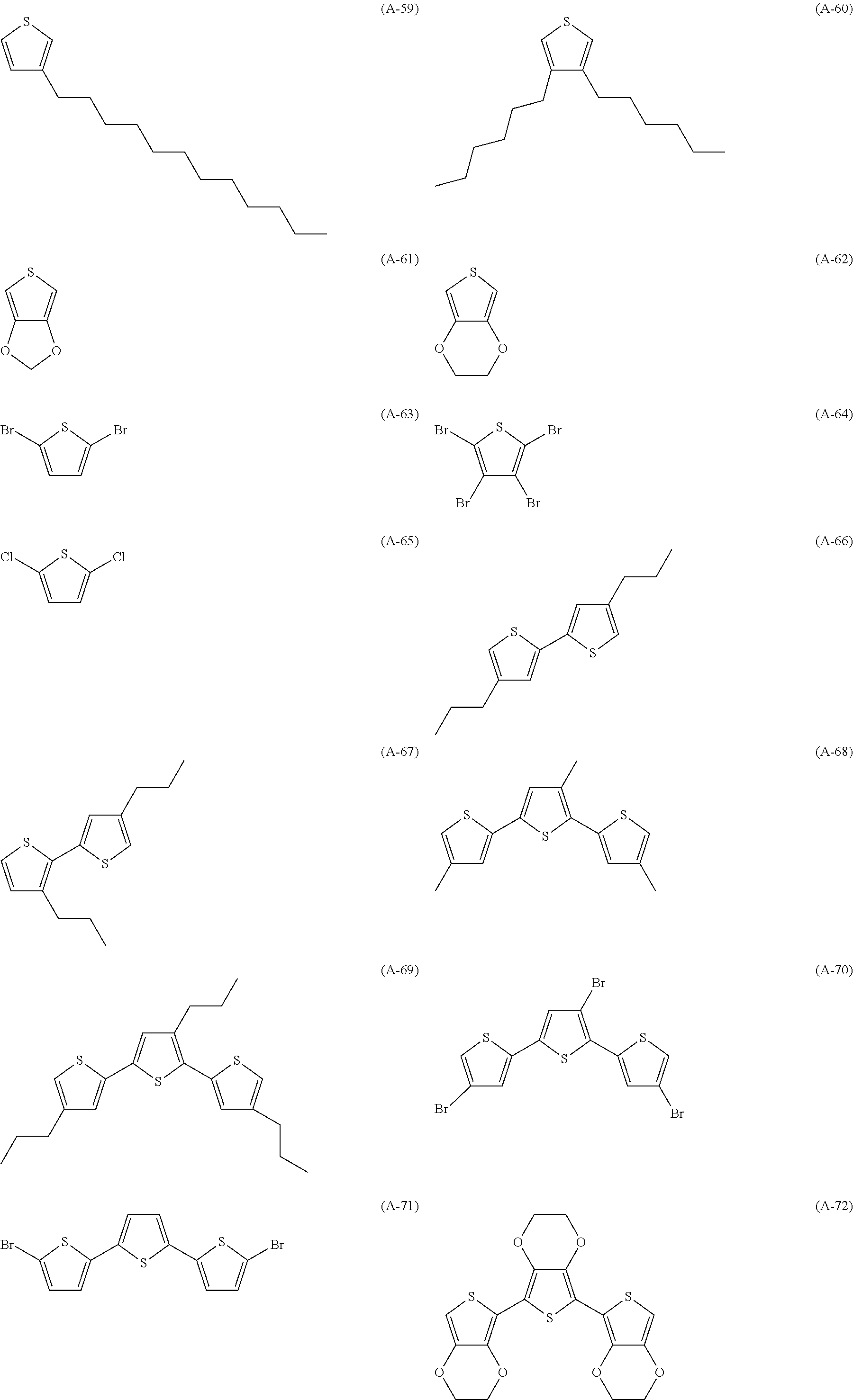

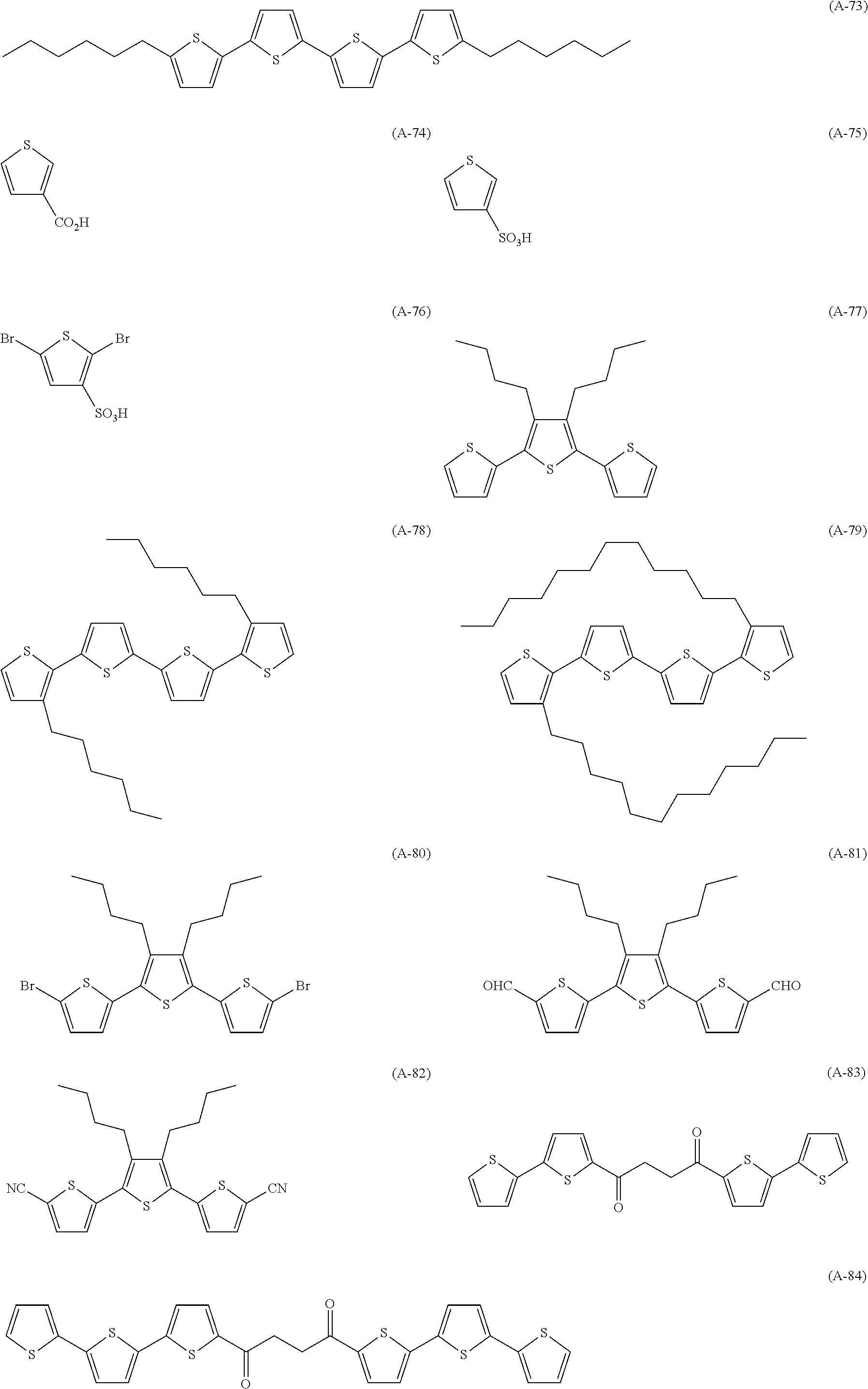

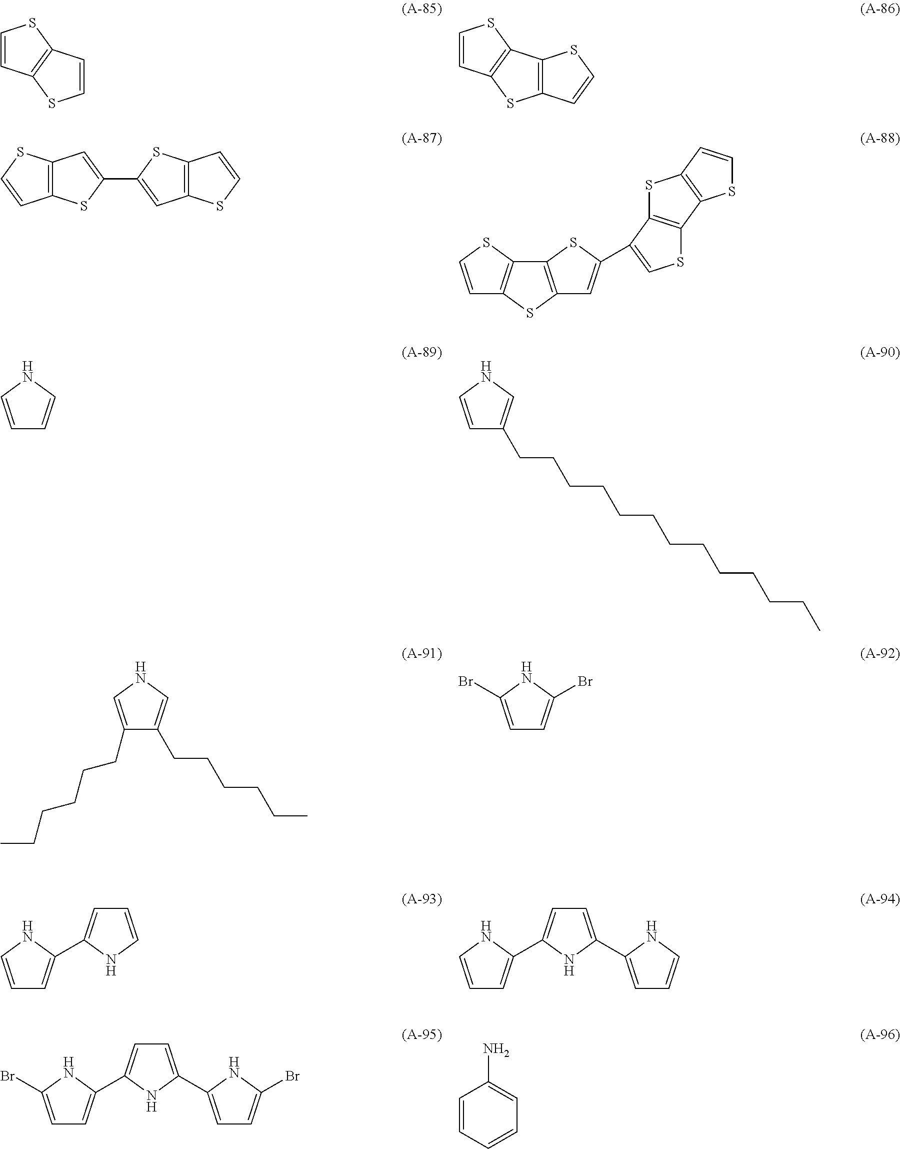

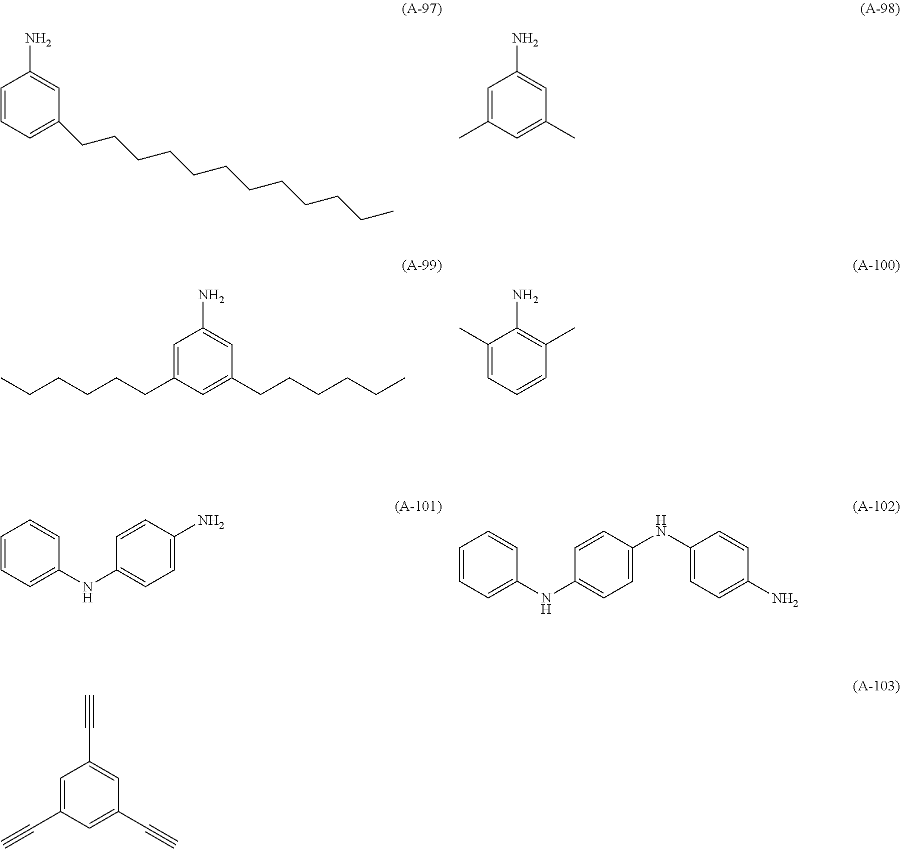

The plasma-initiated polymerizable composition may contain two or more conductive polymer precursors. The plasma-initiated polymerizable composition may contain additives (e.g., polymerization initiator and chain transfer agent and the like) so far as the advantages of the invention are not affected, but it preferably contains the compound as a main component, and the proportion of the at least one conductive polymer precursor in the composition (excluding the solvent in solvent-containing embodiments of the composition, such as coating solutions) is preferably 50% by mass or more, more preferably 80% by mass or more, and may be even 100% by mass.

The plasma-initiated polymerizable composition may contain at least one of (B) a polymerization initiator, (C) a chain transfer agent, (D) a binder, (E) a doping agent, and (F) a solvent, if desired. The polymerization initiator and chain transfer agent contribute to the improvement of the degree of polymerization of acetylene, while the binder contributes to the improvement of surface evenness of coating layers after plasma irradiation. Other additives such as surfactants may also be contained. The additives are specifically described below.

(B) Polymerization Initiators

The polymerization initiator (B) that can be used in the present invention is not specifically limited, and may be either a thermal initiator or a photoinitiator. A suitable type can be selected depending on the type of the conductive polymer precursor, the properties of the plasma used for irradiation and the type of the plasma-generating gas. Thermal initiators generating radicals upon heating that can be used include organic peroxides such as lauroyl peroxide and benzoyl peroxide; azo initiators such as azobisbutyronitrile (AIBN) and V-30, V-40, V-59, V-65, V-70, V-601, VF-096, VAm-110, VAm-111 (from Wako Pure Chemical Industries, Ltd.) and the like. Especially, UV initiators generating radicals or the like upon UV irradiation are preferably used for inducing a nitrogen plasma using nitrogen gas because such a plasma involves UV emission. Various UV initiators can be used, including α-aminoketones, α-hydroxyketones, phosphine oxides, oxime esters, titanocenes and the like. They are commercially available (e.g., IRGACURE 907, DAROCURE 1173, IRGACURE 184, IRGACURE 369, IRGACURE 379, IRGACURE 819, IRGACURE 784, IRGACURE OXE 01, IRGACURE OXE 02 and the like from BASF Japan Ltd.). Preferably, the polymerization initiator (B) is a peroxide.

The amount of the polymerization initiator (B) added into the composition is preferably 0.1 to 10% by mass, more preferably 0.3 to 5% by mass, even more preferably 0.5 to 3% by mass based on the solids excluding the solvent.

(C) Chain Transfer Agents:

The chain transfer agent (C) that can be used in the present invention is not specifically limited, and a suitable type can be selected depending on the type of the conductive polymer precursor used with it. For example, it can be selected from thiol compounds having a mercapto group, specifically including 3-mercaptopropyl trimethoxysilane, β-mercaptopropionic acid, methyl-3-mercaptopropionate, 2-ethylhexyl-3-mercaptopropionate, n-octyl-3-mercaptopropionate, n-octyl mercaptan, n-dodecyl mercaptan, trimethylolpropane tris(3-mercaptopropionate), tris[(3-mercaptopropionyloxy) ethyl]isocyanurate, tetraethylene glycolbis(3-mercaptopropionate), dipentaerythritol hexakis(3-mercaptopropionate) and the like.

(D) Binders:

The binder (D) that can be used in the present invention is not specifically limited, and a suitable type can be selected depending on the type of the conductive polymer precursor used with it. Polymers having a molecular weight of about 1000 to 1,000,000 are preferred, specifically including polystyrene, poly(meth)acrylate, polyester, polyethylene terephthalate, nylon, vinylon, polyamide, polyimide, polyurethane, polyethylene, polypropylene, polyvinyl chloride, fluorinated polyethylene, fluorinated polypropylene, phenol resins, polyvinyl acetate, polyethylene oxide, polyvinyl alcohol, polyvinyl acetal, polyvinyl butyral, polycarbonate, butadiene rubber, silicone rubber, silicone oil, cellulose and the like. A combination of two or more of them may also be used.

(E) Doping Agents

During plasma irradiation, a doping agent (dopant) can be introduced into the polymer by adding the dopant into the coating layer system. The dopant used is not specifically limited so far as it is a typical acceptor dopant, and examples include halogens such as chlorine, bromine and iodine; Lewis acids such as phosphorus pentafluoride; protonic acids such as hydrogen chloride and sulfuric acid; transition metal chlorides such as iron (III) chloride; transition metal compounds such as silver perchlorate and silver fluoroborate; and organic semiconductors such as tetracyanoquinodimethane (TCNQ). Such a dopant may not be necessarily introduced in the present invention, but conductivity can be further improved by introducing a dopant.

A dispersant may be used so far as the performance of the conductive polymer obtained by plasma irradiation is not affected, or a (poly)anion may be used in place of a dispersant if it exists as a dopant. Preferably, the dispersant has the function of (1) rapidly adsorbing to the surfaces of precipitated microparticles to form fine particles, and (2) preventing reaggregation of these particles. In the present invention, low molecular weight or high molecular weight anionic, cationic, zwitterionic, or nonionic dispersants can be used as such dispersants. These dispersants can be used alone or in combination.

Anionic dispersants include polystyrene sulfonates, acyl methyl taurate salts, fatty acid salts, alkyl sulfate ester salts, alkyl benzene sulfonate salts, alkyl naphthalene sulfonate salts, dialkyl sulfosuccinate salts, alkyl phosphate ester salts, naphthalene sulfonate formaldehyde condensates, polyoxyethylene alkyl sulfate ester salts and the like. Especially, polystyrene sulfonates and acyl methyl taurate salts are preferred. These anionic dispersants can be used alone or as a combination of two or more of them.

Cationic dispersants include quaternary ammonium salts, alkoxylated polyamines, aliphatic amine polyglycol ethers, aliphatic amines, diamines and polyamines derived from aliphatic amines and aliphatic alcohols, imidazolines derived from fatty acids and salts of these cationic materials. These cationic dispersants can be used alone or as a combination of two or more of them.

Zwitterionic dispersants are dispersants having both of an anionic group moiety contained in the molecules of the anionic dispersants and a cationic group moiety contained in the molecules of the cationic dispersants in their molecules.

Nonionic dispersants include polyoxyethylene alkyl ethers, polyoxyethylene alkyl aryl ethers, polyoxyethylene fatty acid esters, sorbitan fatty acid esters, polyoxyethylene sorbitan fatty acid esters, polyoxyethylene alkylamines, glycerol fatty acid esters and the like polyoxyethylene alkyl aryl ethers are preferred. These nonionic dispersants can be used alone or as a combination of two or more of them.

(F) Solvents:

In the present invention, a composition containing a solvent in combination with the component (A) is used. The solvent is not specifically limited in principle so far as the solubility of each component and coatability are satisfied. In embodiments containing a binder, for example, it will be selected taking into consideration the solubility of the binder, coatability, and safety. One or more organic solvents can be used as solvents. Water, and a solvent mixture of water with one or more organic solvents can also be used as solvents.

Examples of the solvents include various solvents described in paragraph [0187] of JP-A2008-32803. Specifically, examples of organic solvents that can be used as solvents include esters such as ethyl acetate, n-butyl acetate, isobutyl acetate, amyl formate, isoamyl acetate, isobutyl acetate, butyl propionate, isopropyl butyrate, ethyl butyrate, butyl butyrate, methyl lactate, ethyl lactate, oxyacetic acid alkyl esters (e.g., methyl oxyacetate, ethyl oxyacetate, butyl oxyacetate (specifically, methyl methoxyacetate, ethyl methoxyacetate, butyl methoxyacetate, methyl ethoxyacetate, ethyl ethoxyacetate and the like)), 3-oxypropionic acid alkyl esters (e.g., methyl 3-oxypropionate, ethyl 3-oxypropionate and the like (specifically, methyl 3-methoxypropionate, ethyl 3-methoxypropionate, methyl 3-ethoxypropionate, ethyl 3-ethoxypropionate and the like)), 2-oxypropionic acid alkyl esters (e.g., methyl 2-oxypropionate, ethyl 2-oxypropionate, propyl 2-oxypropionate and the like (specifically, methyl 2-methoxypropionate, ethyl 2-methoxypropionate, propyl 2-methoxypropionate, methyl 2-ethoxypropionate, ethyl 2-ethoxypropionate and the like)), methyl 2-oxy-2-methylpropionate and ethyl 2-oxy-2-methylpropionate (specifically, methyl 2-methoxy-2-methylpropionate, ethyl 2-ethoxy-2-methylpropionate and the like), methyl pyruvate, ethyl pyruvate, propyl pyruvate, methyl acetoacetate, ethyl acetoacetate, methyl 2-oxobutanoate, ethyl 2-oxobutanoate and the like.

Examples of organic solvents that can be used as solvents also include ethers such as diethylene glycol dimethyl ether, tetrahydrofuran, ethylene glycol monomethyl ether, ethylene glycol monoethyl ether, methyl cellosolve acetate, ethyl cellosolve acetate, diethylene glycol monomethyl ether, diethylene glycol monoethyl ether, diethylene glycol monobutyl ether, propylene glycol monomethyl ether (PGME also known as 1-methoxy-2-propanol), propylene glycol monoethyl ether, propylene glycol monomethyl ether acetate (PGMEA also known as 1-methoxy-2-acetoxypropane), propylene glycol monoethyl ether acetate, propylene glycol monopropyl ether acetate and the like.

Examples of organic solvents that can be used as solvents further include ketones such as methyl ethyl ketone, cyclohexanone, 2-heptanone, 3-heptanone and the like. Further, examples of organic solvents that can be used as solvents include aromatic hydrocarbons such as toluene, xylene and the like.

These organic solvents may be used as a mixture of two or more of them to improve the solubility of each component, the state of the coating surface and the like. In this case, especially preferred are solvent mixtures composed of two or more members selected from methyl 3-ethoxypropionate, ethyl 3-ethoxypropionate, ethyl cellosolve acetate, ethyl lactate, diethylene glycol dimethyl ether, butyl acetate, methyl 3-methoxypropionate, 2-heptanone, cyclohexanone, ethyl carbitol acetate, butyl carbitol acetate, propylene glycol methyl ether, and propylene glycol methyl ether acetate.

Preferably, the content of the solvent in the composition is selected in such a manner that the total solids content of the composition is 5 to 80% by mass, more preferably 5% by mass to 60% by mass, even more preferably 10% by mass to 50% by mass to improve coatability.

(G) Surfactants

The composition used in the present invention may contain one or more surfactants to further improve coatability. Any type of surfactants can be used, including fluorosurfactants, nonionic surfactants, cationic surfactants, anionic surfactants, and silicone surfactants. Further, two or more types of surfactants may be used in combination.

Especially when the composition contains a fluorosurfactant, the liquid properties (especially flowability) of the coating solution prepared therefrom are further improved so that the uniformity of the coating thickness and coating consumption reduction can be further improved. In embodiments where a coating solution prepared from the composition containing a fluorosurfactant is used to form a film, interfacial tension between the substrate surface and the coating solution decreases, whereby wettability on the substrate surface and coatability on the substrate surface are improved. Thus, such embodiments are more effective for forming a thin film because a film of even and uniform thickness can be formed even if a small amount of a coating solution is used to form a thin film in the order of several nanometers to several micrometers.

The fluorine content in the fluorosurfactant is preferably 3% by mass to 40% by mass, more preferably 5% by mass to 30% by mass, especially preferably 7% by mass to 25% by mass. Fluorosurfactants having a fluorine content in the above ranges are effective for obtaining coated films of uniform thickness and for reducing coating consumption, but also they are well soluble in the composition.

Fluorosurfactants include, for example, Megafac F171, F172, F173, F176, F177, F141, F142, F143, F144, R30, F437, F475, F479, F482, F554, F780, F781 (all from DIC Corporation); Fluorad FC430, FC431, FC171 (all from Sumitomo 3M Limited); SURFLON S-382, SC-101, SC-103, SC-104, SC-105, SC1068, SC-381, SC-383, 5393, KH-40 (all from ASAHI GLASS CO., LTD.); Solsperse 20000 (from Lubrizol Japan Limited) and the like.

Nonionic surfactants specifically include polyoxyethylene lauryl ether, polyoxyethylene stearyl ether, polyoxyethylene oleyl ether, polyoxyethylene octylphenyl ether, polyoxyethylene nonylphenyl ether, polyethylene glycol dilaurate, polyethylene glycol distearate, sorbitan fatty acid esters (Pluronic L10, L31, L61, L62, 10R5, 17R2, 25R2, Tetronic 304, 701, 704, 901, 904, 150R1 from BASF) and the like.

Cationic surfactants specifically include phthalocyanine derivatives (available from Morishita Sangyo K.K. under the brand name EFKA-745); organosiloxane polymer KP341 (from Shin-Etsu Chemical Co., Ltd.); (meth)acrylic (co)polymers POLYFLOW No. 75, No. 90, No. 95 (from Kyoeisha Chemical Co., Ltd.); W001 (from Yusho Co., Ltd.); and the like.

Anionic surfactants specifically include W004, W005, W017 (from Yusho Co., Ltd.) and the like.

Silicone surfactants include, for example, “Toray Silicone DC3PA”, “Toray Silicone SH7PA”, “Toray Silicone DC11PA”, “Toray Silicone SH21PA”, “Toray Silicone SH28PA”, “Toray Silicone SH29PA”, “Toray Silicone SH30PA”, and “Toray Silicone SH8400” from Dow Corning Toray Co., Ltd.; “TSF-4440”, “TSF-4300”, “TSF-4445”, “TSF-4460”, and “TSF-4452” from Momentive Performance Materials Inc.; “KP341”, “KF6001”, and “KF6002” from Shin-Etsu Silicone, Co., Ltd.; “BYK307”, “BYK323”, and “BYK330” from BYK Japan KK; and the like.

In the present invention, the composition may or may not contain such surfactants, and if present, they are preferably contained in an amount of 0.001% by mass or more and 1% by mass or less, more preferably 0.01% by mass or more and 0.1% by mass or less based on the total mass of the composition.

Preferably, the plasma-initiated polymerizable composition used in the present invention does not undergo conventional thermal polymerization or photopolymerization at normal temperature to improve storage stability. More preferably, it does not undergo conventional thermal polymerization or photopolymerization at 60° C. for this purpose. Among others, alkyne compounds represented by formula (2) above and polymers having a repeat unit represented by formula (3) above are especially preferred to improve storage stability because they do not undergo any polymerization reaction at all unless they are treated by plasma irradiation.

Whether or not polymerization has proceeded can be determined by observing molecular weight changes by GPC analysis after storage in an environmental test chamber set at 60° C. for one month. If no molecular weight change is detected, it indicates that polymerization has not proceeded, while a molecular weight change of 5% or more indicates that polymerization has proceeded.

(2) Processes for Preparing Cured Films

In the preparation processes of the present invention, the composition containing at least one conductive polymer precursor is applied on the surface of a substrate to form a coating layer. This step can be performed by conventional coating techniques such as spin coating, extrusion coating, direct gravure coating, reverse gravure coating, die coating, for example. Further, inkjet techniques can also be used. For some purposes, the composition may be applied in a pattern such as a striped or lattice pattern. Alternatively, a coating layer may be formed by immersing the substrate in the polymerizable composition prepared as an immersion solution. Further, the solvent may be removed by heating after coating. The heating temperature can be determined depending on the boiling point of the solvent used.

The substrate is not specifically limited in any aspects such as shape, material and the like. It may be in any of tubular, plane or strip shape. It may also be a substrate having pores such as a porous body, in which case a film may be formed on the insides of the pores. Further, the substrate may be made from any of organic materials, inorganic materials, and hybrid materials thereof. Specifically, glass, metals, organic polymers, inorganic polymers, organic-inorganic hybrid materials, fibers and the like can be used. The processes of the present invention are especially useful in embodiments using a substrate made from an organic polymer because it need not be exposed to excessively high temperatures for inducing a polymerization reaction. The surface of the substrate on which a film is formed may be flat or curved, and may have small irregularities. Specifically, examples of substrates on which the film is formed include not only films, boards and sheets, but also filter papers, membrane filters, resin tubes, cloth, cotton, felt, and feather and the like, but the present invention is not limited to these examples.

Then, the coating layer formed is irradiated with a plasma whereby a polymerization reaction of the conductive polymer precursor starts and proceeds. A low temperature atmospheric pressure plasma generated under conditions of approximately atmospheric pressure is preferably used. For example, non-equilibrium plasma jets, low temperature plasmas generated by AC-pulsed discharges and the like can be used, all of which are preferably generated under conditions of approximately atmospheric pressure.

Various atmospheric pressure plasma systems can be used for plasma irradiation. For example, a preferred system can generate a low temperature plasma by intermittent discharge while passing an inert gas at approximately atmospheric pressure between dielectric-covered electrodes, but any system can be used, and various variations can be selected depending on the purpose of use and the like. More specifically, the following systems can be used: the system used for treating a substrate with a plasma in JP-A2008-60115; the normal pressure plasma system described in JP-A2004-228136; the plasma systems described in the specifications of JP-A2006-21972, JP-A2007-188690, and International Publications WO2005/062338, WO2007/024134, WO2007/145513 and the like. Atmospheric pressure plasma systems are also commercially available, and atmospheric pressure plasma systems currently on the market can also be conveniently used, including ATMP-1000 from ARIOS INC.; the atmospheric pressure plasma systems from Haiden Lab Inc; the atmospheric pressure low temperature plasma jet system model S5000 from SAKIGAKE-Semiconductor Co., Ltd.; MyPL100, ILP-1500 from WELL Corporation; RD550 from SEKISUI CHEMICAL CO., LTD.; for example. However, systems having a specially designed electric circuit are preferably used to reduce damage to the coating layer by avoiding local enhancement of plasma (called streamer), such as the systems described in the specifications of WO/2005/062338 and WO2007/024134 wherein power is supplied to the discharge part via a pulse controller, for example.

As used herein, “approximately atmospheric pressure” in “atmospheric pressure plasma” refers to a range of 70 kPa or more and 130 kPa or less, preferably a range of 90 kPa or more and 110 kPa or less.

Discharge gases that can be used for generating an atmospheric pressure plasma include any of nitrogen, oxygen, hydrogen, argon, helium, ammonia and carbon dioxide gases, or a mixture of two or more of these gases. Preferably, inert gases are used, including rare gases such as He and Ar or nitrogen gas (N₂), among which rare gases such as Ar or He are especially preferred. When a plasma is applied to the surface of the coating layer, the conductive polymer precursor in the coating layer is polymerized and cured by the plasma to form a cured film. Application of a plasma to the surface of the coating layer allows a polymerization reaction to rapidly start and proceed. In polymerization by plasma irradiation, active species (e.g., radicals) contained in the plasma adhere to the surface of the coating layer so that polymerization (e.g., radical polymerization) starts from the surface.

The plasma treatment here may be performed in a batch process or in-line with other steps.

To reduce damage to the surface of the coating layer, it is effective to separate the plasma attack site from the discharge site or to generate a homogeneous plasma by specially designing the discharge circuit to reduce local enhancement of plasma (called streamer), and especially, the latter is preferable in that a homogeneous plasma treatment can be achieved over a large area. The former is preferably a method wherein a plasma generated by discharge is transported by an inert gas stream to the surface of the coating layer to come into contact with it, especially preferably the so-called plasma jet method. In this case, the passage (conducting tube) through which the inert gas containing a plasma is transported is preferably made from a dielectric material such as glass, porcelain, organic polymer or the like. The latter is preferably the method described in WO/2005/062338 and WO2007/024134 wherein a homogeneous glow plasma is generated with reduced streamers by supplying power to dielectric-covered electrodes via a pulse controller.

The distance from the nozzle supplying an inert gas containing a plasma to the surface of the coating layer is preferably 0.01 mm to 100 mm, more preferably 1 mm to 20 mm.

In the method where a plasma is transported by an inert gas, the plasma can also be applied in-line to the surface of the coating layer in the same manner as the method described in WO2009/096785. Specifically, a coating layer for forming an organic thin film is formed by a coating technique and an outlet nozzle or the like capable of applying an inert gas and a plasma to the surface is provided downstream of the coating step, whereby the organic thin film can be continuously formed.
The method using an inert gas to generate a plasma has the advantage that polymerization reaction is less influenced by oxygen inhibition and good curability can be achieved even in an open system because the plasma directly acts on a plasma-initiated polymerizable compound in the coating layer so that polymerization/curing reaction efficiently starts and proceeds in contrast to conventional methods requiring a closed environment of an inert gas atmosphere to prevent oxygen inhibition.

To reduce incorporation of oxygen-derived chemical species during polymerization reaction, the region to be treated with a plasma may be thoroughly supplied with an inert gas or filled with an inert gas. In cases where a plasma is transported by such an inert gas, the plasma-generating site preferably has been placed under a stream of the inert gas before plasma ignition and continues to be under a stream of the inert gas after plasma extinction.

After plasma treatment, the inert gas may be discharged without being specially treated because the plasma's life is short, or the treated inert gas may be recovered through a suction port near the treating region.

Any temperature can be selected during plasma irradiation depending on the properties of the materials in the coating layer to be irradiated with a plasma, but the temperature rise caused by irradiation with an atmospheric pressure low temperature plasma is preferably small because damage can be reduced. This effect is further improved by separating the plasma attack site from the plasma generator.

In the processes described above, the heat energy supplied from the plasma can be decreased and the temperature rise in the coating layer may be reduced by selecting an atmospheric pressure low temperature plasma for irradiation. The temperature rise in the coating layer caused by plasma irradiation is preferably 50° C. or less, more preferably 40° C. or less, especially preferably 20° C. or less.

Preferably, the temperature during plasma irradiation is the maximum temperature that the materials in the coating layer irradiated with the plasma can endure or less, typically −196° C. or more and less than 150° C., more preferably −21° C. or more and 100° C. or less. Especially preferred are temperatures near room temperature (25° C.) in an atmosphere of environmental temperature.

A cured film is formed on at least a part of the surface of the substrate by the processes described above. The thickness of the resulting cured film is not specifically limited, but the plasma-assisted processes of the present invention are advantageous for forming a thin film, and specifically, the thickness of the cured film prepared by the processes of the present invention is preferably 1 to 500 nm, more preferably 1 to 200 nm, even more preferably 1 to 100 nm.

According to the processes of the present invention, films having a high degree of cure can be obtained. Specifically, films having a degree of cure of 30% or more, preferably 60% or more, more preferably 65% or more, even more preferably 70% or more can be formed. Some conductive polymer precursors form cured films by conventional thermal polymerization or photopolymerization, oxidative polymerization or the like, but they require high temperatures (e.g., 150° C. or more) or high voltage application from electrodes to form films having the degree of cure indicated above so that the polymer film or the like used for the substrate is inevitably deteriorated. Further, a long time (e.g., 10 hours or more) is often required for conductive polymer precursors capable of undergoing conventional thermal polymerization or photopolymerization, oxidative polymerization or the like to be cured at a degree of cure in the ranges indicated above. In contrast, the present invention allows films having the degree of cure indicated above to be formed rapidly (e.g., within one minute) so that it is also advantageous in rapid film formation.

Preferably, the present invention may also employ a process comprising applying a composition containing (A) at least one conductive polymer precursor on a substrate to form a coating layer and then partially irradiating the coating layer with a plasma to partially polymerize the conductive polymer precursor (A), thereby forming a surface having different surface resistivities. When such a process is employed, a patterned organic conductive film can be formed, which comprises a discrete region having a surface resistivity of 10²Ω/□ or more and a discrete region having a surface resistivity of less than 10²Ω/□ in the same surface.

Cured films prepared by the preparation processes of the present invention can be used for various applications such as optical materials, electric materials, medical materials, electronic materials, aerospace materials, gas barrier materials, conductive materials, antistatic materials and the like. Especially, they are useful as gas barrier materials and the like because they have a high degree of cure and excellent durability such as heat resistance and moisture resistance.

2. Cured Films, and Plasma-Initiated Polymerizable Compositions

The present invention also relates to films obtained by curing a composition containing at least one kind selected from a compound represented by formula (2) below and a polymer or oligomer having a repeat unit represented by formula (3) below, as well as plasma-initiated polymerizable compositions comprising at least one kind selected from a compound represented by formula (2) below, and a polymer having a repeat unit represented by formula (3) below. The definition and preferred range of each group in the formulae are the same as described above. Processes for preparing the films and applications thereof and the like are also the same as described above.

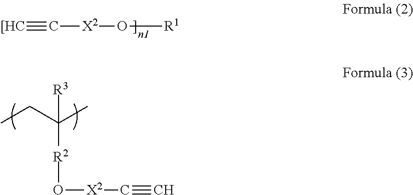

In formulae (2) and (3), R¹ represents a parent structure of a polyhydric alcohol or a parent structure of a polyhydric phenol, X² represents a divalent group consisting of an alkylene group optionally interrupted by one or more carbonyl groups, one or more heteroatoms or a combination thereof, an arylene group optionally interrupted by one or more heteroatoms, a heteroarylene group optionally interrupted by one or more heteroatoms, or a combination thereof, wherein these groups may have one or more substituents; n1 represents an integer of 2 to 6; R² represents a single bond, an alkylene group optionally interrupted by one or more carbonyl groups, one or more heteroatoms or a combination thereof, or an arylene group optionally interrupted by one or more heteroatoms; and R³ represents a hydrogen atom, or an alkyl group.

### EXAMPLE

Features of the present invention will further be detailed referring to Examples. Note that the amount of use, ratio, details of processes, and procedures of processes described in Examples below may be arbitrarily modified, without departing from the spirit of the present invention. The scope of the present invention is, therefore, not restrictively understood by the specific examples described below.

1. Synthesis of Conductive Polymer Compound Precursors

### Synthesis Example 1

### Synthesis of Decanediol Dipropargyl Ether (A-10)

In a 200 mL-flask, 10.0 g of decanediol was introduced and diluted with 50 mL of THF. This solution was stirred with 13.9 g of powdered potassium hydroxide at room temperature for 1 hour. To this was added 1.6 g of potassium iodide, and then 29.4 g of propargyl bromide was added dropwise over 30 minutes. During then, the reaction mixture changed from a white to brown suspension. After stirring at 40° C. at 9 hours, the reaction mixture was filtered under suction and the organic solvent in the filtrate was distilled off under reduced pressure. The residue was purified by column chromatography (hexane/ethyl acetate=10/1) to give 5.1 g of (A-10) (as a pale yellow liquid).

¹HNMR (400 MHz, CDCl₃): 1.2 (m, 12H), 1.6 (m, 4H), 2.41 (t, 2H), 3.55 (t, 4H), 4.15 (d, 4H).

### Synthesis Example 2

### Synthesis of Polyethylene Glycol Dipropargyl Ether (A-16)

(A-16) was synthesized in the same manner as in Synthesis example 1 except that decanediol was replaced by polyethylene glycol (Mn≈600). This gave 8.3 g of (A-16) (as a pale yellow liquid).

¹HNMR (400 MHz, CDCl₃): 2.46 (t, 2H), 3.7 (m, 60H), 4.21 (d, 4H).

### Synthesis Example 3

### Synthesis of Pentaerythritol Tetrapropargyl Ether (A-32)

(A-32) was synthesized in the same manner as in Synthesis example 1 except that decanediol was replaced by pentaerythritol. This gave 4.5 g of (A-32) (as a pale yellow crystal).

¹HNMR (400 MHz, CDCl₃): 2.40 (t, 4H), 3.52 (s, 8H), 4.12 (d, 8H).

### Synthesis Example 4

### Synthesis of Dipentaerythritol Hexapropargyl Ether (A-34)

The same procedure as in Synthesis example 1 was followed except that decanediol was replaced by dipentaerythritol. This gave 1.5 g of (A-34) (as a pale yellow liquid).

¹HNMR (400 MHz, CDCl₃): 2.40 (t, 6H), 3.38 (s, 4H), 3.53 (s, 12H), 4.12 (d, 12H).

2. Preparation of Compositions Containing a Conductive Polymer Compound Precursor

### (1) Example 1

A mixed solution of the components in the amounts shown below was filtered through a 0.1 μm filter made of tetrafluoroethylene to prepare a plasma-reactive coating solution of Example 1.

| | |
|---|---|
| (A) Conductive polymer precursor (A-1) | 100 parts by mass |
| Solvent: methyl ethyl ketone (MEK) | 900 parts by mass |

### (2) Examples 1 to 29, and Comparative Examples 1 to 9

Coating solutions were prepared in the same manner as in Example 1 except that the composition was replaced by those shown in the tables below.

3. Preparation of Cured Films

### (Formation of Coating Layers)

Each coating solution obtained as described above was applied on a copper foil substrate by spin coating, and then heated on a hot plate at 60° C. for 1 minute to give a plasma-reactive coating layer. As described in the tables, the coating layer was subjected to an atmospheric pressure N₂ plasma treatment, helium plasma treatment, heat treatment, or high pressure mercury lamp treatment.

(Atmospheric Pressure N₂ Plasma Treatment)

The coating layer was irradiated with a low temperature N₂ plasma for 30 seconds using the atmospheric pressure low temperature plasma jet system model 55000 from SAKIGAKE-Semiconductor Co., Ltd. (discharge gas: nitrogen), whereby polymerization reaction proceeded and the coating layer was cured to form a plasma polymerized film having a thickness of 500 nm.

(Helium Plasma Treatment)

The coating layer was irradiated with a helium plasma for 30 seconds using the atmospheric pressure low temperature plasma jet system model 55000 from SAKIGAKE-Semiconductor Co., Ltd. (discharge gas: helium), whereby polymerization reaction proceeded and the coating layer was cured to form a plasma polymerized film having a thickness of 500 nm.

(Heat Treatment)

A coating layer having a thickness of 500 nm was formed in the same manner as described above and heated on a hot plate at 150° C. for 30 seconds, whereby thermal polymerization proceeded to form a cured film.

(High Pressure Mercury Lamp Treatment)

A coating layer having a thickness of 500 nm was formed in the same manner as described above and irradiated with UV light at a dose of 1 J/cm² instead of the atmospheric pressure plasma using the UV lamp UV LIGHT SOURCE EX250 (from HOYA-SCHOTT).

4. Performance Evaluation

Each coating composition and each film were evaluated as follows.

(1) Storage Stability

Each coating composition prepared as described above was stored in an environmental test chamber set at 60° C. for one month. This solution was analyzed by GPC to observe molecular weight changes. Evaluation was made according to the following standards:

3: No molecular weight change was detected.
2: Molecular weight change of less than 5%.
1: Molecular weight change of 5% or more.

(2) Degree of Cure

The degree of cure of each cured film obtained was determined from the decrease in the areas of peaks appearing at 2100 cm⁻¹ to 2200 cm⁻¹ attributed to stretching frequencies of triple bonds characteristic of alkyne functional groups using FT-IR (from VARIAN) and evaluated according to the following standards. Higher values of this degree indicate that sufficient polymerization has occurred.

4: 90% or more
3: 60% or more and less than 90%
2: 30% or more and less than 60%
1: less than 30%.

(3) Heat Resistance

The cured film obtained after plasma treatment was scraped by a spatula and heated at a rate of 10° C./min in a thermogravimetric analyzer (TGA from TA Instruments), during which weight changes were read. The temperature T at which a 1% weight loss occurred was determined as the maximum allowable temperature and evaluated according to the following standards. The maximum allowable temperature T is preferably higher, which indicates a stable cured product at high temperatures.

4: 350° C. or more
3: 300° C. or more and less than 350° C.
2: 250° C. or more and less than 300° C.
1: less than 250° C.

(4) Moisture Resistance

The refractive index of the transparent cured film obtained after plasma treatment was determined using an ellipsometer (VASE) from J. A. Woollam JAPAN Co., Inc. at a wavelength of 633 nm. Then, the film was subjected to forced aging under hot and humid conditions at 80° C., 85% humidity for 3 days and the refractive index was determined by the same procedure. The difference Δn in refractive index at the initial time and after aging was calculated and evaluated according to the following standards. The difference Δn in refractive index is preferably smaller, which indicate a stable cured product even under high humidity conditions.

4: Refractive index difference Δn of less than 0.005
3: Refractive index difference Δn of 0.005 or more and less than 0.01
2: Refractive index difference Δn of 0.01 or more and less than 0.03
1: Refractive index difference Δn of 0.03 or more.

(5) Solubility

The coating solution prepared was visually observed for the solubility of the composition in the solvent and evaluated as follows.

3: Totally dissolved.
2: A small amount of solid remains undissolved.
1: Not dissolved.

(6) Coating Evenness

Immediately after the composition was applied, the coating layer was observed by light microscopy and evaluated as follows.

3: An even layer was formed.
2: Slight unevenness was observed.
1: A considerably uneven and non-uniform coating layer was obtained.

(7) Surface Resistivity

The cured film obtained was analyzed for the value measured by using a surface resistivity meter (Hiresta MCP-HT450 from Mitsubishi Chemical Analytech Co., Ltd.).

TABLE 1

| | | | | | | | | | Heat | |
|---|---|---|---|---|---|---|---|---|---|---|
| | | (A′)Com- | (B)Polymeri- | (C)Chain | | | | | resistance | Moisture |
| | (A) Alkyne | parative | zation | transfer | | | Storage | Degree | temper- | resis- |
| | compound | compound | initiator | agent | (D)Binder | Treatment | stability | of cure | ature(T) | tance(Δn) |
| Example 1 | A-1 (100) | — | — | — | — | Atmospheric pres- | 3 | 2 | 2 | 2 |
| | | | | | | sure N₂ plasma | | | | |
| Example 2 | A-10 (100) | — | — | — | — | Atmospheric pres- | 3 | 3 | 2 | 3 |
| | | | | | | sure N₂ plasma | | | | |
| Example 3 | A-16 (100) | — | — | — | — | Atmospheric pres- | 3 | 3 | 2 | 2 |
| | | | | | | sure N₂ plasma | | | | |
| Example 4 | A-20 (100) | — | — | — | — | Atmospheric pres- | 3 | 3 | 2 | 2 |
| | | | | | | sure N₂ plasma | | | | |
| Example 5 | A-21 (100) | — | — | — | — | Atmospheric pres- | 3 | 3 | 3 | 3 |
| | | | | | | sure N₂ plasma | | | | |
| Example 6 | A-27 (100) | — | — | — | — | Atmospheric pres- | 3 | 3 | 4 | 3 |
| | | | | | | sure N₂ plasma | | | | |
| Example 7 | A-32 (100) | — | — | — | — | Atmospheric pres- | 3 | 4 | 4 | 3 |
| | | | | | | sure N₂ plasma | | | | |
| Example 8 | A-33 (100) | — | — | — | — | Atmospheric pres- | 3 | 4 | 3 | 3 |
| | | | | | | sure N₂ plasma | | | | |
| Example 9 | A-34 (100) | — | — | — | — | Atmospheric pres- | 3 | 4 | 4 | 4 |
| | | | | | | sure N₂ plasma | | | | |
| Example 10 | A-34 (40) | — | — | — | D-1(60) | Atmospheric pres- | 3 | 3 | 3 | 3 |
| | | | | | | sure N₂ plasma | | | | |
| Example 11 | A-40 (100) | — | — | — | — | Atmospheric pres- | 3 | 4 | 4 | 4 |
| | | | | | | sure N₂ plasma | | | | |
| Example 1 2 | A-43 (100) | — | — | — | — | Atmospheric pres- | 3 | 3 | 4 | 3 |
| | | | | | | sure N₂ plasma | | | | |
| Example 13 | A-48 (100) | — | — | — | — | Atmospheric pres- | 3 | 4 | 3 | 3 |
| | | | | | | sure N₂ plasma | | | | |
| Example 14 | A-49 (100) | — | — | — | — | Atmospheric pres- | 3 | 4 | 3 | 3 |
| | | | | | | sure N₂ plasma | | | | |
| Example 15 | A-34(40)/ | — | — | — | — | Atmospheric pres- | 3 | 4 | 4 | 4 |
| | A-48(60) | | | | | sure N₂ plasma | | | | |
| Example 16 | A-34(40)/ | — | — | — | — | Atmospheric pres- | 3 | 4 | 4 | 4 |
| | A-49(60) | | | | | sure N₂ plasma | | | | |
| Example 17 | A-34(40)/ | — | B-1(3) | — | — | Atmospheric pres- | 3 | 4 | 3 | 3 |
| | A-49(57) | | | | | sure N₂ plasma | | | | |
| Example 18 | A-34(40)/ | — | B-1(3) | C-1(3) | — | Atmospheric pres- | 3 | 4 | 3 | 3 |
| | A-49(54) | | | | | sure N₂ plasma | | | | |
| Example 19 | A-34(40)/ | — | — | — | — | Atmospheric pres- | 3 | 4 | 4 | 4 |
| | A-49(60) | | | | | sure He plasma | | | | |
| Comparative | — | A′-1 (100) | — | — | — | Atmospheric pres- | 2 | 3 | 1 | 1 |
| example 1 | | | | | | sure N₂ plasma | | | | |
| Comparative | — | A′-1 (97) | B-1(3) | — | — | Atmospheric pres- | 1 | 4 | 1 | 1 |
| example 2 | | | | | | sure N₂ plasma | | | | |
| Comparative | — | A′-1 (94) | B-1(3) | C-1(3) | — | Atmospheric pres- | 1 | 4 | 1 | 1 |
| example 3 | | | | | | sure N₂ plasma | | | | |
| Comparative | A-34(40)/ | — | B-1(3) | C-1(3) | — | High pressure | 3 | 1 | Avaluative | Avaluative |
| example 4 | A-49(54) | | | | | mercury lamp | | | | |

The values in parentheses represent the amounts of the respective components expressed in parts by mass.

TABLE 2

| | (A)Conductive | (A′) | | | | | | | |
|---|---|---|---|---|---|---|---|---|---|
| | polymer | Comparative | | (E)Doping | | Storage | | Coating | Surface |
| | precursor | compound | (D)Binder | agent | Treatment | stability | Solubility | evenness | resistivity(Ω/□) |
| Example 20 | A-19 (30) | — | D-1(70) | — | Atmospheric | 3 | 3 | 3 | 6.3 × 10⁹ |
| | | | | | pressure N₂ plasma | | | | |
| Example 21 | A-20 (30) | — | D-1(70) | — | Atmospheric | 3 | 3 | 3 | 8.4 × 10⁹ |
| | | | | | pressure N₂ plasma | | | | |
| Example 22 | A-55 (30) | — | D-1(70) | — | Atmospheric | 3 | 3 | 3 | 2.7 × 10⁸ |
| | | | | | pressure N₂ plasma | | | | |
| Example 23 | A-56 (30) | — | D-2(70) | — | Atmospheric | 2 | 3 | 3 | 1.2 × 10⁸ |
| | | | | | pressure N₂ plasma | | | | |
| Example 24 | A-94 (30) | — | D-2(70) | — | Atmospheric | 2 | 3 | 3 | 6.9 × 10¹⁰ |
| | | | | | pressure N₂ plasma | | | | |
| Example 25 | A-101 (30) | — | D-2(70) | — | Atmospheric | 3 | 3 | 3 | 8.6 × 10⁸ |
| | | | | | pressure N₂ plasma | | | | |
| Example 26 | A-55 (25) | — | D-1(70) | E-1(5) | Atmospheric | 3 | 3 | 3 | 5.1 × 10⁴ |
| | | | | | pressure N₂ plasma | | | | |
| Example 27 | A-55 (25) | — | D-1(70) | E-2(5) | Atmospheric | 3 | 3 | 3 | 9.3 × 10³ |
| | | | | | pressure N₂ plasma | | | | |
| Example 28 | A-103 (25) | — | D-1(70) | E-1(5) | Atmospheric | 3 | 3 | 3 | 6.6 × 10³ |
| | | | | | pressure N₂ plasma | | | | |
| Example 29 | A-103 (25) | — | D-1(70) | E-2(5) | Atmospheric | 3 | 3 | 3 | 2.9 × 10³ |
| | | | | | pressure N₂ plasma | | | | |
| Comparative | — | — | D-1(100) | — | Atmospheric | 3 | 3 | 3 | >10¹⁵ |
| example 5 | | | | | pressure N₂ plasma | | | | |
| Comparative | — | — | D-1(95) | E-2(5) | Atmospheric | 3 | 3 | 3 | >10¹⁵ |
| example 6 | | | | | pressure N₂ plasma | | | | |
| Comparative | — | A′-2(25) | D-1(70) | E-2(5) | Atmospheric | 1 | 1 | 1 | 9.1 × 10⁵ |
| example 7 | | | | | pressure N₂ plasma | | | | |
| Comparative | — | A′-3(25) | — | — | Atmospheric | 1 | 2 | 2 | 3.5 × 10³ |
| example 8 | | | | | pressure N₂ plasma | | | | |
| Comparative | A-55 (25) | — | D-1(70) | E-2(5) | High pressure | 3 | 3 | 3 | >10¹⁵ |
| example 9 | | | | | mercury lamp | | | | |

The values in parentheses represent the amounts of the respective components expressed in parts by mass.

(A′-1) Dipentaerythritol Hexaacrylate (DPHA from Shin-Nakamura Chemical Co., Ltd.)

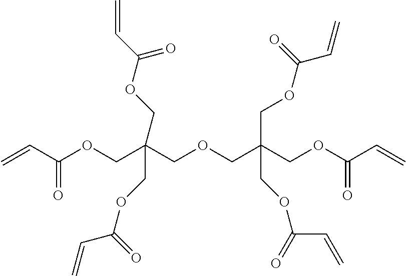 [SMILES: C=CC(=O)OCC(COCC(COC(=O)C=C)(COC(=O)C=C)COC(=O)C=C)(COC(=O)C=C)COC(=O)C=C]

(A′-2) Poly(3-hexylthiophene) (P3HT) (698997 from Sigma-Aldrich Japan K.K.)
(A′-3) Microparticles of indium tin oxide (ITO) (ITO from Mitsubishi Material Electronic Chemicals Co., Ltd.)

(B-1) IRGACURE 379 (from BASF Japan Ltd.)

(B-2) Dicumyl peroxide (from Tokyo Chemical Industry Co., Ltd.)

(C-1) Pentaerythritol tetrakis(3-mercaptobutyrate) (Karenz MT-PE1 from Showa Denko K.K.)

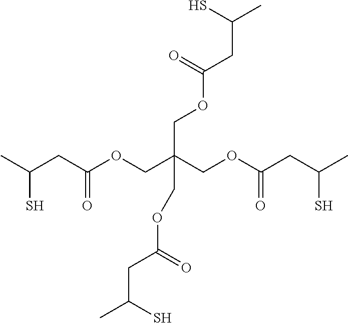 [SMILES: CC(S)CC(=O)OCC(COC(=O)CC(C)S)(COC(=O)CC(C)S)COC(=O)CC(C)S]

(D-1) Polystyrene (molecular weight 30000) (from WAKO) (81408 from Sigma-Aldrich Japan K.K.)

(D-2) Poly(methyl methacrylate) (molecular weight 30000) (81499 from Sigma-Aldrich Japan K.K.)

(E-1) Iodine (096-05425 from Wako Pure Chemical Industries, Ltd.)

(E-2) Tetracyanoquinodimethane (TCNQ) (T0078 from Tokyo Chemical Industry Co., Ltd.)

It can be understood from the results shown in the tables above that storage stability was improved by using conductive polymer precursors as compared with conventional acrylic monomers. Especially, the compounds represented by formula (2) above and the polymers having a repeat unit represented by formula (3) above were not cured at all by a conventional UV curing system, but could be cured only when they were combined with plasma irradiation. Further, the surface resistance remained high when the conductive polymer precursors were subjected to UV irradiation or when films containing no conductive polymer precursor were subjected to plasma irradiation, but the surface resistance could be lowered only when the conductive polymer precursors were combined with plasma irradiation.

Further, the resulting films were excellent in heat resistance and moisture resistance due to the high crosslink density derived from alkyne polymerization so that they can be expected to be applied for various technical fields such as optical materials and electric materials and the like.

Conductive polymer precursors are preferably polyfunctional rather than monofunctional to improve the degree of cure. Further, conductive polymer precursors preferably have a molecular weight of 230 or more to improve the degree of cure. Especially, conductive polymer precursors are most preferably polyfunctional and have a molecular weight of 230 or more and are combined with a polymer that is also a conductive polymer precursor to improve the degree of cure. When the degree of cure is improved, a compact and firm three-dimensional crosslink structure is formed, resulting in a cured film having excellent heat resistance and moisture resistance. It should be noted that the compositions containing an initiator or a chain transfer agent are improved in the degree of cure, but somewhat disadvantageous in heat resistance and moisture resistance because low-molecular weight components derived from these additives remain.

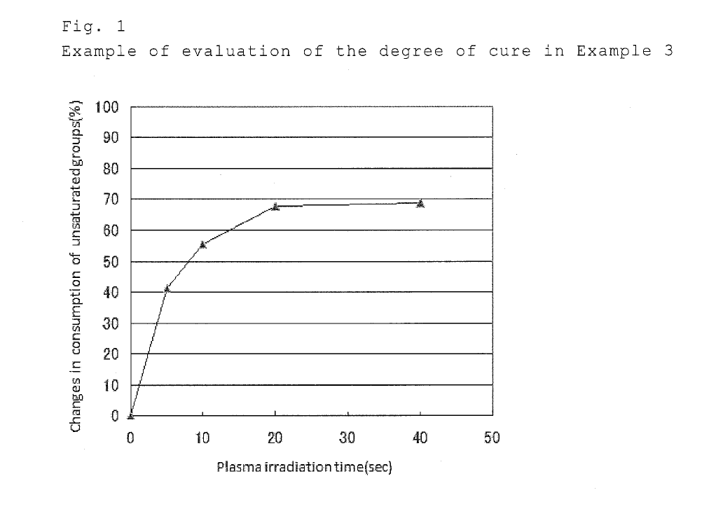

All of the Examples were found to reach the degree of cure at saturation within one minute. As an example, FIG. 1 shows the results of changes in consumption of unsaturated groups vs. the plasma irradiation time monitored in Example 3.

For example, compound A-1 can be polymerized by photopolymerization or thermal polymerization, but requires a high temperature of 150° C. or more to reach a degree of cure exceeding 50% or requires a time of 10 hours or more to reach such a degree of cure.

The present disclosure relates to the subject matter contained in Japanese Patent Application No. 184373/2011, filed on Aug. 26, 2011, and Japanese Patent Application No. 025062/2012, filed on Feb. 8, 2012, which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

1. A process for preparing a cured film, comprising at least:
applying a composition containing (A) at least one conductive polymer precursor on a substrate to form a coating layer, and then
irradiating the coating layer with a plasma to polymerize the conductive polymer precursor (A).

2. The process for preparing a cured film according to claim 1, wherein the conductive polymer precursor (A) contains at least one of aromatic groups, heteroaromatic groups and alkynyl groups.

3. The process for preparing a cured film according to claim 1, wherein the conductive polymer precursor (A) is a precursor of a polymer having any one kind of polythiophene, polyaniline, polypyrrole, and polyacetylene as the main backbone.

4. The process for preparing a cured film according to claim 1, wherein the conductive polymer precursor (A) is a compound having a molecular weight of 230 or more.

5. The process for preparing a cured film according to claim 1, wherein the conductive polymer precursor (A) is a compound having two or more terminal ethynyl groups in one molecule.

6. The process for preparing a cured film according to claim 1, wherein the conductive polymer precursor (A) is a compound having a partial structure represented by formula (1) below:
HC≡C—X— Formula (1)
wherein formula (1), X represents a divalent group consisting of an alkylene group optionally interrupted by one or more carbonyl groups, one or more heteroatoms or a combination thereof, an arylene group optionally interrupted by one or more heteroatoms, a heteroarylene group optionally interrupted by one or more heteroatoms, or a combination thereof, wherein these groups may have one or more substituents.

7. The process for preparing a cured film according to claim 1, wherein the conductive polymer precursor (A) is a compound represented by formula (1a): 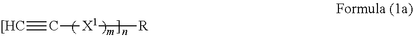
wherein formula (1a), X¹ represents a divalent group consisting of an alkylene group optionally interrupted by one or more carbonyl groups, one or more heteroatoms or a combination thereof, an arylene group optionally interrupted by one or more heteroatoms, a heteroarylene group optionally interrupted by one or more heteroatoms, or a combination thereof, wherein these groups may have one or more substituents; m represents 0 or 1; n represents a number of 1 to 10; R represents a hydrogen atom, a single bond, a n-valent organic group, or a residue of a repeat unit constituting a polymer or an oligomer; and when n is 2 or more, two or more CH≡C—(X¹)ₘ— moieties may be the same or different.

8. The process for preparing a cured film according to claim 1, wherein the conductive polymer precursor (A) is a compound represented by formula (2) below, or a polymer having a repeat unit represented by formula (3) below: 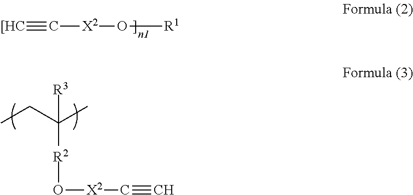
wherein formulae (2) and (3), R¹ represents a parent structure of a polyhydric alcohol or a parent structure of a polyhydric phenol; X² represents a divalent group consisting of an alkylene group optionally interrupted by one or more carbonyl groups, one or more heteroatoms or a combination thereof, an arylene group optionally interrupted by one or more heteroatoms, a heteroarylene group optionally interrupted by one or more heteroatoms, or a combination thereof, wherein these groups may have one or more substituents; n1 represents an integer of 2 to 6; R² represents a single bond, an alkylene group optionally interrupted by one or more carbonyl groups, one or more heteroatoms or a combination thereof, or an arylene group optionally interrupted by one or more heteroatoms; and R³ represents a hydrogen atom, or an alkyl group.

9. The process for preparing a cured film according to claim 8, wherein X² in formulae (2) and (3) represents an alkylene group containing 1 to 5 carbon atoms.

10. The process for preparing a cured film according to claim 1, wherein the composition further contains at least one of (B) a polymerization initiator, (C) a chain transfer agent, (D) a binder, (E) a doping agent, and (F) a solvent.

11. The process for preparing a cured film according to claim 10, wherein the polymerization initiator (B) is a peroxide.

12. The process for preparing a cured film according to claim 10, wherein the chain transfer agent (C) is a thiol compound.

13. The process for preparing a cured film according to claim 1, wherein the substrate is a polymer film.

14. The process for preparing a cured film according to claim 1, wherein the cured film has a surface resistivity of 10¹²Ω/□ or less.

15. The process for preparing a cured film according to claim 1, wherein the plasma is a low temperature atmospheric pressure plasma.

16. The process for preparing a cured film according to claim 1, wherein the plasma is formed from any one or more of nitrogen, oxygen, hydrogen, argon, helium, ammonia and carbon dioxide gases.

17. A cured film prepared by polymerizing the conductive polymer precursor (A) by the process according to claim 1.

18. The cured film according to claim 17, which has a thickness of 1 to 500 nm.

19. A cured film having a surface resistivity of less than 10¹²Ω/□ prepared by the process according to claim 1.
